(19) United States
(12) Patent Application Publication
(10) Pub. No.: US 2009/0237740 A1
(43) Pub. Date: Sep. 24, 2009

(54) Method for Obtaining Correction Values and Liquid Ejecting Apparatus

(75) Inventor: Hirokazu KASAHARA, Okaya-shi (JP)

Correspondence Address: HOGAN & HARTSON L.L.P., 1999 AVENUE OF THE STARS, SUITE 1400, LOS ANGELES, CA, 90067, US

(73) Assignee: Seiko Epson Corporation, Tokyo (JP)

(21) Appl. No.: 12/406,340

(22) Filed: Mar. 18, 2009

(30) Foreign Application Priority Data
Mar. 19, 2008 (JP) 2008-072190

(51) Int. Cl. G06K 15/00

(52) U.S. Cl. 358/3.27

(57) ABSTRACT

A method for obtaining correction values, includes: forming, on a medium, a correction pattern in which a plurality of dot rows extending along a predetermined direction are lined up in a direction intersecting the predetermined direction; obtaining a correction-pattern reading density of each of the dot rows of the correction pattern together with a standard-pattern reading density of a standard pattern, by reading the correction pattern together with the standard pattern; and obtaining a density correction value that is used in correcting a density of an image, for each of the dot rows, based on the correction-pattern reading density, with respect to a target density that is set based on the standard-pattern reading density.

### CROSS-REFERENCE TO RELATED APPLICATIONS

The present application claims priority from Japanese Patent Application No. 2008-72190 filed on Mar. 19, 2008, which are herein incorporated by reference.

### BACKGROUND

1. Technical Field

The invention relates to methods for obtaining density correction values and liquid ejecting apparatuses.

2. Related Art

There is known a liquid ejecting apparatus, such as an inkjet printer, that includes nozzles and forms an image on a medium (paper, cloth, etc.) by ejecting liquid from the nozzles onto the medium. In liquid ejecting apparatuses of the type described, density unevenness occurs in an image formed on a medium because of variation in manufacturing accuracy of the nozzles and the like.

In order to suppress such density unevenness as this, a technique to correct the density of the image have been proposed, for example (e.g., see JP-A-2005-205691). In this technique, the density of the image is corrected using a correction value of the density (hereinafter referred to as a density correction value) that is obtained based on the reading density of a correction pattern that is formed on a medium and read.

Besides, in order to obtain the density correction values, it can be considered that in addition to the correction pattern, a standard pattern (to be described later) is prepared and is read. The reading density of this standard pattern is used to set a target density used in obtaining the density correction values. That is, the density correction value can be obtained based on the reading density of the correction pattern using the reading density of the standard pattern as the target density.

however, because the reading sensitivity with which the standard pattern and correction pattern is read fluctuates with time, there is a risk that these two patterns are read with different reading sensitivities if the standard pattern and the correction pattern are not read simultaneously. Due to such fluctuation of the reading sensitivity, there is a possibility that an appropriate value is not set as the target density, and an appropriate density correction value cannot be obtained. This results in difficulty in suppressing occurrences of the foregoing density unevenness.

### SUMMARY

An advantage of some aspects of the invention is to obtain appropriate density correction values.

A primary aspect of the invention for achieving the above-described advantage is a method for obtaining correction values, including: forming, on a medium, a correction pattern in which a plurality of dot rows extending along a predetermined direction are lined up in a direction intersecting the predetermined direction; obtaining a correction-pattern reading density of each of the dot rows of the correction pattern together with a standard-pattern reading density of a standard pattern, by reading the correction pattern together with the standard pattern; and obtaining a density correction value that is used in correcting a density of an image, for each of the dot rows, based on the correction-pattern reading density, with respect to a target density that is set based on the standard-pattern reading density.

Other features of the invention will become clear by reading the description of the present specification with reference to the accompanying drawings.

### BRIEF DESCRIPTION OF THE DRAWINGS

FIG. 1 is a block diagram showing the configuration of a printing system 100 including a printer 1.

FIGS. 2A and 2B are diagrams showing the configuration of the printer 1.

FIG. 3 is a diagram showing an arrangement of nozzles.

FIG. 4 is a flowchart of printing.

FIGS. 5A and 5B are explanatory diagrams of interlaced printing.

FIG. 6 is an explanatory diagram of operations of a printer driver.

FIG. 7 is an explanatory diagram of halftoning.

FIG. 8A is a diagram showing a state of raster lines that have been formed ideally. FIG. 8B is a diagram showing a state of raster lines when density unevenness occurs. FIG. 8C is a diagram showing a state of raster lines when the occurrence of the density unevenness is suppressed.

FIG. 9 is a graph describing an influence of fluctuation of the reading sensitivity of a scanner 120.

FIG. 10 is a block diagram showing the configuration of a correction-value obtaining system 200.

FIG. 11 is a flowchart of a process for obtaining correction values.

FIG. 12 is an explanatory diagram of a standard pattern SP.

FIG. 13 is an explanatory diagram of a correction pattern CP.

FIG. 14A is a schematic view showing the internal configuration of the scanner 120. FIG. 14B is a diagram showing how the scanner 120 reads the correction pattern CP and the standard pattern SP.

FIG. 15 is a diagram showing the image data of the correction sub-pattern CSP.

FIG. 16 is an explanatory diagram showing a reading-density table.

FIG. 17 is an explanatory diagram of procedures for obtaining the density correction value H.

FIG. 18 is an explanatory diagram of a correction-value table.

FIG. 19 is an explanatory diagram of a density correcting process.

FIG. 20 is an explanatory diagram describing an influence in the case where the standard pattern SP and correction pattern CP are formed on different types of paper from each other.

FIG. 21 is a block diagram showing the configuration of a correction-value obtaining system 300 of the first modified example.

FIG. 22 is a flowchart of a correction-value obtaining process of the first modified example.

FIG. 23 is an explanatory diagram of procedures for setting a density as a target density in the first modified example.

FIG. 24 is an explanatory diagram of a line printer including an elongated head 23.

FIG. 25 is an explanatory diagram of a line printer including a plurality of heads 23.

### DESCRIPTION OF EXEMPLARY EMBODIMENTS

At least the following matters will be made clear by the description of the present specification and the accompanying drawings.

First, method for obtaining correction values, including: forming, on a medium, a correction pattern in which a plurality of dot rows extending along a predetermined direction are lined up in a direction intersecting the predetermined direction; obtaining a correction-pattern reading density of each of the dot rows of the correction pattern together with a standard-pattern reading density of a standard pattern, by reading the correction pattern together with the standard pattern; and obtaining a density correction value that is used in correcting a density of an image, for each of the dot rows, based on the correction-pattern reading density, with respect to a target density that is set based on the standard-pattern reading density.

With this method for obtaining correction values, since the correction pattern are read together with the standard pattern, the correction pattern and standard pattern are read with the same reading sensitivity. This enables the appropriate density correction values to be obtained without being influenced by the fluctuation of the reading sensitivity.

Further, in the above-mentioned method for obtaining correction values, the standard pattern may have a plurality of standard sub-patterns that are different in density from each other; in forming the correction pattern on the medium, the correction pattern having a plurality of correction sub-patterns that are different in density from each other may be formed in such a manner as each of the correction sub-patterns mates with one of the standard sub-patterns and the mated correction sub-pattern and standard sub-pattern have a same density; in obtaining the correction-pattern reading density together with the standard-pattern reading density, a correction-sub-pattern reading density of each of the dot rows of each of the correction sub-patterns may be obtained together with a standard-sub-pattern reading density of each of the standard sub-patterns; and in obtaining the density correction value, the density correction value may be obtained for each dot row using a standard-sub-pattern reading density of one of the plurality of standard sub-patterns as the target density, based on a correction-sub-pattern reading density of a correction sub-pattern that mate with that standard sub-pattern and a correction-sub-pattern reading density of at least one of a correction sub-pattern other than the correction sub-pattern that mates with that standard sub-pattern. With this method for obtaining correction values, it is possible to easily set the target density.

Further, in obtaining the correction-pattern reading density together with the standard-pattern reading density, a scanner including a plurality of reading sensors arranged in a line may read the correction pattern together with the standard pattern, with the mated standard sub-pattern and correction sub-pattern being lined up at a same position in a direction in which the reading sensors are arranged. As a result, it is possible to suppress influence of difference in reading sensitivity between the reading sensors.

Further, in the above-mentioned method for obtaining correction values, the standard pattern may have a plurality of standard sub-patterns that are different in density from each other; measuring a color value of each of the standard sub-patterns by a color measurement device may be included; in forming the correction pattern on the medium, the correction pattern having a plurality of correction sub-patterns that are different in density from each other may be formed on the medium in such a manner as a color value of each of the correction sub-patterns is the same as a target color value determined with respect to that correction sub-pattern; in obtaining the correction-pattern reading density together with the standard-pattern reading density, a correction-sub-pattern reading density of each of the dot rows of each of the correction sub-patterns maybe obtained together with a standard-sub-pattern reading density of each of the standard sub-patterns; and in obtaining the density correction value, the density correction value may be obtained for each dot row using, as the target density, a density corresponding to a target color value of one of the plurality of correction sub-patterns, based on a correction-sub-pattern reading density of that correction sub-pattern and a correction-sub-pattern reading density of at least one of a correction sub-pattern other than that correction sub-pattern, the target color value being obtained based on a correspondence between the color value of the standard sub-pattern and the standard-sub-pattern reading density.

With this method for obtaining correction values, the correction pattern does not have to be formed in such a manner as each of the correction sub-patterns mates with any one of the standard sub-patterns, and the correction sub-pattern and standard sub-pattern that mate with each other have the same density. Therefore, formation of the correction pattern becomes easier.

Further, in the above-mentioned method for obtaining correction values, in forming the correction pattern on the medium, the correction pattern may be formed on a different medium from a medium on which the standard pattern is formed. With this method for obtaining correction values, it is possible to omit to form the standard pattern every time a process for obtaining density correction values is performed, for example.

Further, in forming the correction pattern on the medium, the correction pattern may be formed on a medium of a same type as the medium on which the standard pattern is formed, with a liquid of a same type as a liquid used in forming the standard pattern.

Further, it is also possible to achieve a liquid ejecting apparatus, including: a nozzle that ejects liquid; a controller that makes the nozzle eject the liquid and forms on a medium a correction pattern in which a plurality of dot rows extending along a predetermined direction are lined up in a direction intersecting the predetermined direction; and a memory that stores a density correction value used in correcting a density of an image, and that is obtained for each dot row using, as a target density, a density that is set based on a standard-pattern reading density of a standard pattern read together with the correction pattern, based on a correction-pattern reading density obtained for each of the dot rows by reading the correction pattern.

With this liquid ejecting apparatus, the appropriate density correction values are stored in the memory of the liquid ejecting apparatus. Therefore, when forming an image on a medium, the density for each dot row can appropriately be corrected based on the density correction values. As a result, it is possible to appropriately suppress the occurrence of density unevenness in the image.

### Printing System

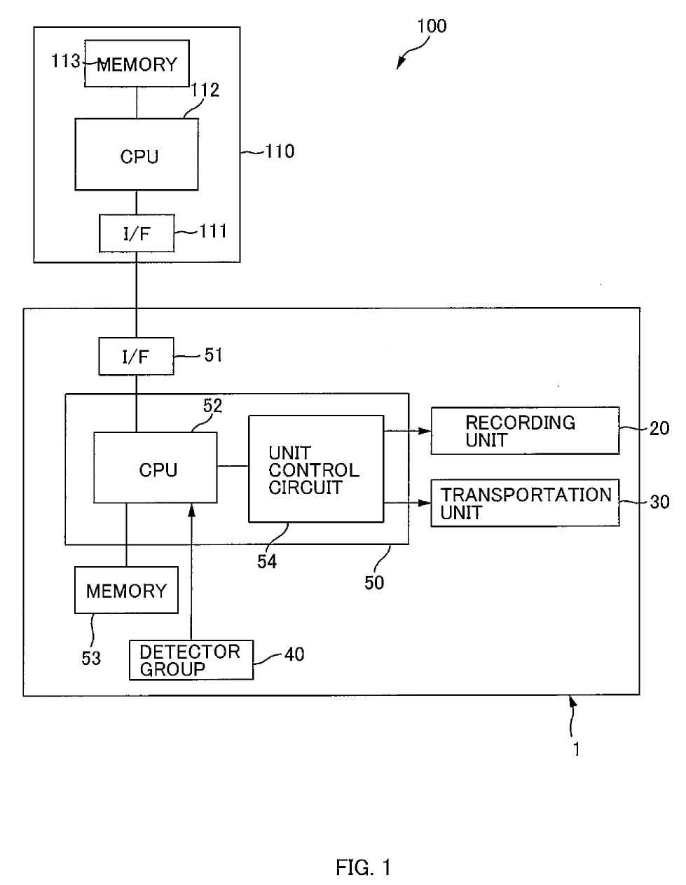

The outline of a printing system including an inkjet printer (hereinafter referred to as a printer 1), which serves as a liquid ejecting apparatus of this embodiment, is described with reference to FIG. 1. FIG. 1 is a block diagram showing the configuration of a printing system 100 including the printer 1.

The printing system 100 of this embodiment includes the printer 1 and a computer 110 that controls operations of the printer 1, as shown in FIG. 1.

The printer 1 is a printing apparatus that prints an image on a medium by ejecting ink, which serves as liquid, on the medium. In the following, an example of printing an image on paper, which is a typical medium, is described. The computer 110 is communicably connected to the printer 1 through an interface 111. In order to make the printer 1 print an image, the computer 110 outputs print data corresponding to the image to the printer 1. The computer 110 has a printer driver installed thereon, and the printer driver is a program that functions to convert image data outputted from an application program into print data.

### Configuration of Printer 1

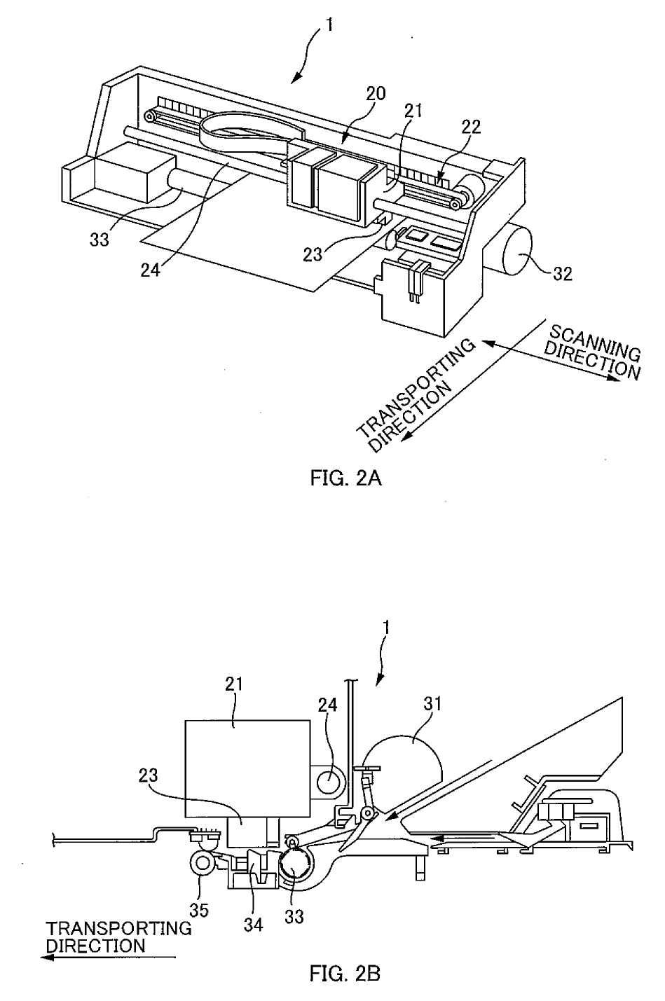

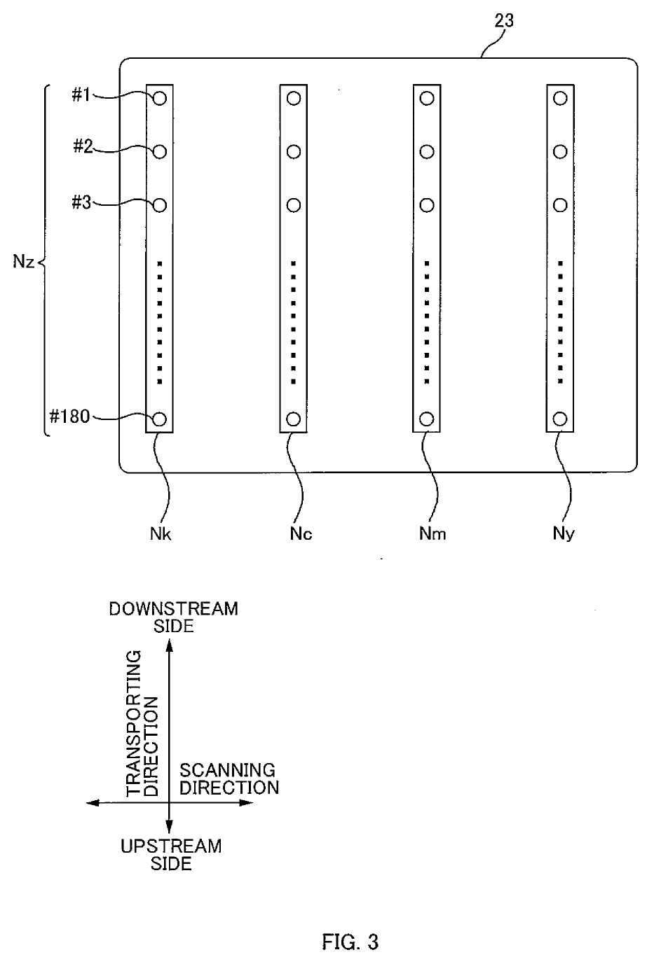

Next, with reference to FIGS. 1 and 3, the configuration of the printer 1 is described. FIGS. 2A and 2B are diagrams showing the configuration of the printer 1; FIG. 2A is a schematic diagram showing the overall configuration of the printer 1, and FIG. 2B is a cross-sectional view of the overall configuration of the printer 1. The arrows in FIG. 2A indicate a moving direction (scanning direction) of a head 23 and a transporting direction of paper, and the arrow in FIG. 2B indicates the transporting direction. FIG. 3 is a diagram showing an arrangement of nozzles, and the arrows in the figure indicate the transporting direction and the scanning direction.

As shown in FIG. 1, the printer 1 includes a recording unit 20, a transportation unit 30, a detector group 40, and a controller 50. When the printer 1 receives print data from the computer 110, the controller 50 controls units (the recording unit 20 and the transportation unit 30) based on the print data and print an image on paper. Conditions within the printer 1 are monitored by the detector group 40, which outputs signals according to detection results to the controller 50.

The recording unit 20 forms dot rows (hereinafter referred to as raster lines) along a predetermined direction on paper by ejecting ink on the paper, and includes a carriage 21, a carriage moving mechanism 22, and the head 23, as shown in FIGS. 2A and 2B. The predetermined direction in this embodiment is a moving direction of the carriage 21 (scanning direction), and is along a width direction of paper (paper-width direction). With being supported a guide shaft 24, the carriage 21 is moved by the carriage moving mechanism 22 along the guide shaft 24. That is, an axial direction of the guide shaft 24 is a moving direction of the carriage 21.

The head 23 has, in a lower surface thereof, a plurality of nozzles that eject ink. As shown in FIG. 3, n number (in this embodiment, n=180) of the nozzles are lined in the transporting direction at a constant nozzle pitch to form a nozzle row Nz. In the lower surface of the head 23, nozzle rows Nc, Nm, Ny, Nk are formed for each color of ink (CMYK). Each nozzle is provided with an ink chamber and a piezo element (both are not shown); driving the piezo element causes the ink chamber to extend and contract, and the nozzle ejects an ink droplet. As shown in FIGS. 2A and 2B, since the head 23 is provided on the carriage 21, the head 23 moves in the scanning direction as the carriage 21 moves. By ejecting ink from the nozzles intermittently when the head 23 is moving, raster lines are formed along the scanning direction. Each of the nozzles of each nozzle row ejects ink in order to form a dot row assigned to the nozzle.

The transportation unit 30 is for transporting paper in the transporting direction intersecting the scanning direction, and includes a paper supply roller 31, a transportation motor 32, a transportation roller 33, a platen 34, and a paper discharge roller 35, as shown in FIGS. 2A and 2B. After inserting a sheet of paper into an paper-insert opening, when the sheet is supplied by the paper supply roller 31 into the printer 1, the transportation roller 33 that is rotated by the rotation of the transportation motor 32 transports the sheet with a direction that intersects the paper-width direction being along the transporting direction, until the sheet reaches a printable region in the transporting direction. Thereafter, the sheet continues to be transported in the transporting direction with being supported by the platen 34, and is finally discharged by the paper discharge roller 35 out of the printer 1.

The controller 50 controls the units of the printer 1 using a CPU 52 through a unit control circuit 54. The printer 1 includes a memory 53 having a storage device, and in the memory 53, density correction values H are stored that are used in correcting the image density.

### Printing Process

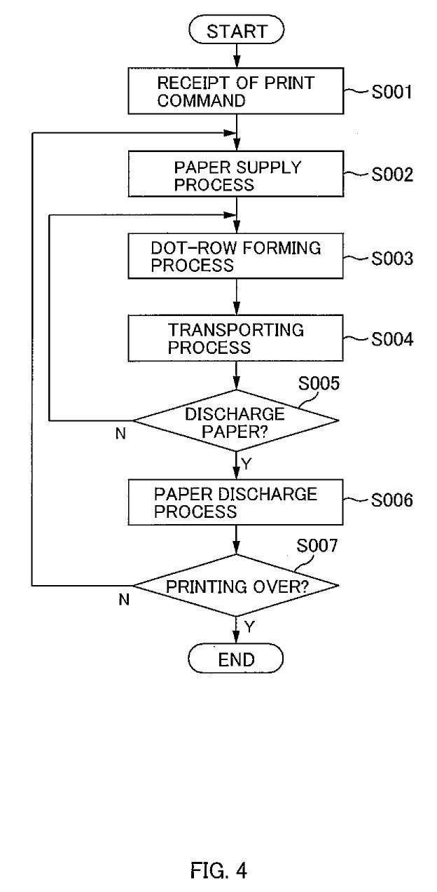

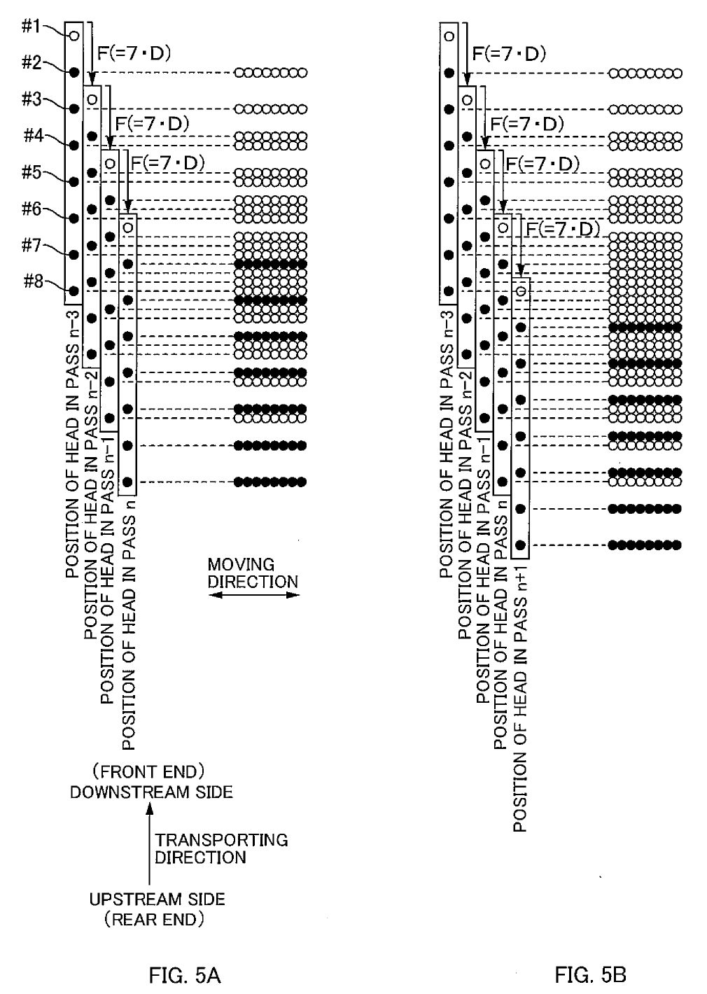

Next, a printing process performed by the printer 1 having the above-mentioned configuration is described with reference to FIGS. 4, 5A, and 5B. FIG. 4 is a flowchart of the printing process. FIGS. 5A and 5B are explanatory diagrams of interlaced printing.

The printing process, as shown in FIG. 4, starts from when the controller 50 receives print data including a print command from the computer 110 through an interface 51 (S001). The controller 50 analyzes the content of various commands included in the print data received, and controls the units of the printer 1. Then, the controller 50 causes the paper supply roller 31 to supply paper, which serves as a printing medium, to the inside of the printer 1, and performs a paper supply process in which the transportation roller 33 positions the paper at a print start position (indexed position) (S002).

Next, the controller 50 performs a dot-row forming process in which a raster line is formed along the scanning direction on the paper by causing nozzles of the head 23 to intermittently eject ink, the head 23 moving in the scanning direction as the carriage 21 moves (S003). A printing region of paper is composed of a plurality of row regions lined up in the transporting direction; in each dot-row forming process, ink is ejected so that a raster line is formed in one of the plurality of row regions. Here, the row region refers to a rectangular region that is composed of pixels (unit regions) lined up in the scanning direction, the pixel being a virtual square region defined on paper. Then, the controller 50 performs a transporting process in which the transportation unit 30 moves the paper in the transporting direction relative to the head 23 (S004). The transporting process allows a raster line to be formed in a dot-row forming process at a position that is different from a position of a raster line formed in the previous dot-row forming process.

By causing the controller 50 to alternately repeat the dot-row forming process and the transporting process, a plurality of raster lines are formed lined up in a direction intersecting the raster lines (that is, the transporting direction). In this embodiment, interlacing is employed in which a plurality of dot-row forming processes (hereinafter referred to as passes) form raster lines in a complementary manner. In interlacing, the following is performed: as shown in FIGS. 5A and 5B, after performing a certain pass (e.g., pass n) and transporting paper in the transporting direction by a certain transporting amount, in a pass next to the certain pass (e.g., pass n+1), a raster line is formed in a row region that is adjacent to and located downstream in the transporting direction of, a row region in which a raster line is formed in the certain pass. However, in the front-end portion and rear-end portion of paper, raster lines continuously lined up in the transporting direction cannot be formed using interlacing only. Accordingly, in this embodiment, before and after regular printing using interlacing, front-end printing and rear-end printing are performed. Front-end printing is a process in which raster lines are formed in the front-end portion of paper, and rear-end printing is a process in which raster lines are formed in the rear-end portion of paper.

Alternately repeating the dot-row forming process and the transporting process until there is no more print data to be printed on the paper that is being printed, the controller 50 determines discharging paper at a point in time of running out of the print data (S005). At a point in time of the controller 50 determining discharging paper, an image according to the print data is printed on the paper. Thereafter, the controller 50 performs a paper discharge process of discharging paper out of the printer 1 by the paper discharge roller 35 (S006). After paper on which an image is printed is discharged out of the printer 1, the controller 50 determines whether or not to continue printing (S007). If a next sheet of paper is to be printed, the controller 50 returns to the foregoing paper supply process and continues printing. On the other hand, if the next sheet of paper is not to be printed, then printing process is terminated.

### Outline of Operations of Printer Driver

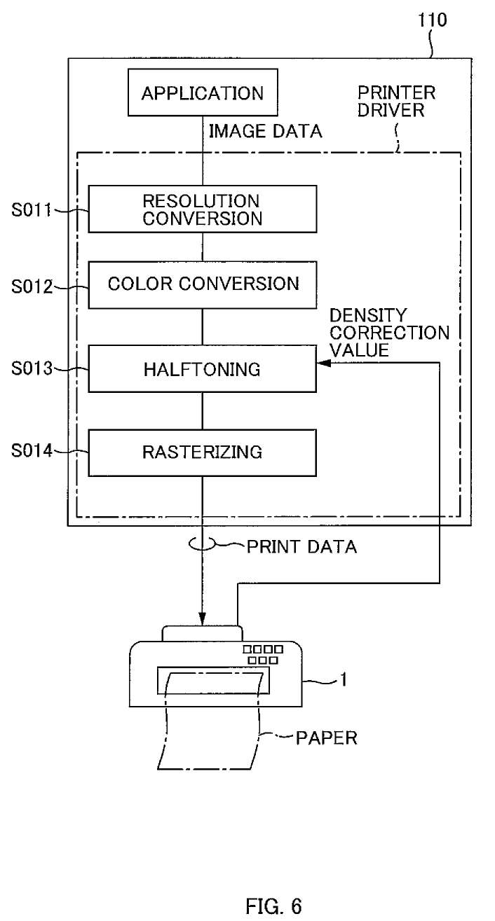

As mentioned above, the printing process starts from when the computer 110 connected to the printer 1 transmits print data. The print data is generated by operations of the printer driver. The operations of the printer driver are described below with reference to FIG. 6. FIG. 6 is an explanatory diagram of the operations of the printer driver.

As shown in FIG. 6, print data is generated as a result that the printer driver performs resolution conversion (S011), color conversion (S012), halftoning (S013), and rasterizing (S014).

In the resolution conversion, the resolution of RGB image data obtained by running an application program converts into a print resolution corresponding to a designated image quality. Next, in the color conversion, the RGB image data that has undergone the resolution conversion is converted into CMYK image data. Note that CMYK image data refers to a series of image data each piece of which corresponds to each color: cyan (C), magenta (M), yellow (Y), and black (K). A plurality of pieces of pixel data that constitute the CMYK image data are each expressed using 256 levels of tone value. The tone value is determined based on the RGB image data, and serves as a designated tone value (input tone value). Next, in the halftoning, tone values of multiple levels with which pieces of pixel data are expressed are converted to dot tone values of fewer levels that can be formed in the printer 1, the pieces of pixel data constituting cyan image data, magenta image data, yellow image data, and black image data. The halftoning is described in detail later. In the rasterizing, the order of pieces of dot data (data of dot tone value) of image data obtained by the halftoning is rearranged into the order of transmission to the printer 1. Then, the data that has undergone rasterizing is transmitted as part of print data.

### Halftoning

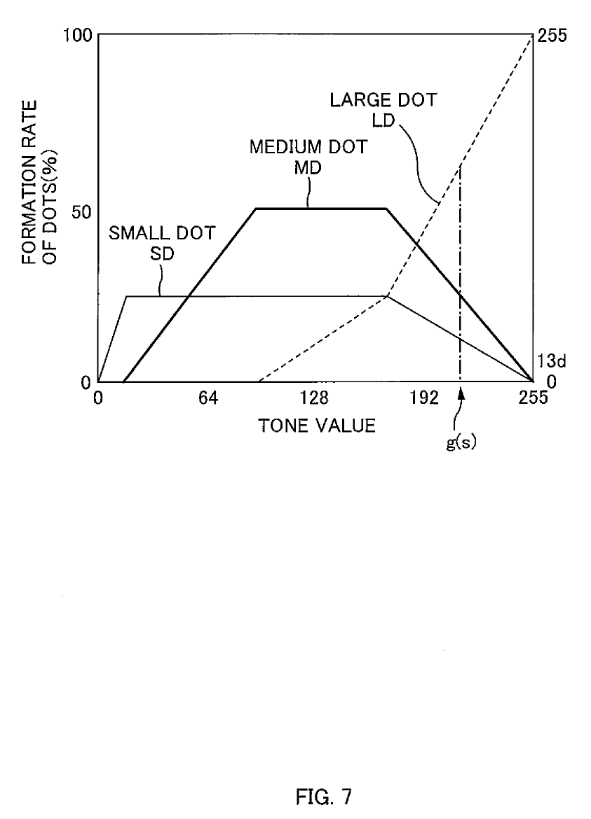

Halftoning is described more specifically with reference to FIG. 7. FIG. 7 is an explanatory diagram of halftoning. In FIG. 7, the vertical axis indicates the formation rate of dots, and the horizontal axis indicates tone value (input tone value). The formation rate of dots refers to a proportion of pixels in which when printing a uniform image of a certain tone value, a dot having a specific size is formed, among pixels in the image. In FIG. 7, the profile SD of the formation rate of small dots is indicated by the thin solid line, the profile MD of the formation rate of medium dots by the thick solid line, and the profile LD of the formation rate of large dots by the dashed line.

In halftoning, 256 levels of the tone value of the pixel data is converted into four levels, more specifically, into the following four levels: non-formation of any dot (corresponding to dot tone value [00]); formation of a small dot (corresponding to dot tone value [01]); formation of a medium dot (corresponding to dot tone value [10]); and formation of a large dot (corresponding to dot tone value [11]). In the example shown in FIG. 7, at tone value g(s), the formation rate of large dots is 65%, the formation rate of medium dots is 25%, the formation rate of small dots is 10%. At these dot formation rates, when printing an image, for example, in a region of 10 pixels by 10 pixels (that is, a region composed of 100 pixels), the number of pixels in which a large dot is formed is 65, a medium dot is 25, and a small dot is 10. In halftoning, as mentioned above, based on the dot formation rate that is determined for each size of the dots, pixel data is generated by dithering, gamma correction, error diffusion, and the like so that the printer 1 forms dots in a distributed manner.

### Correction of Density Unevenness

The section below describes density unevenness that occurs in an image printed with the foregoing printer 1, and a method for suppressing the density unevenness.

### Density Unevenness

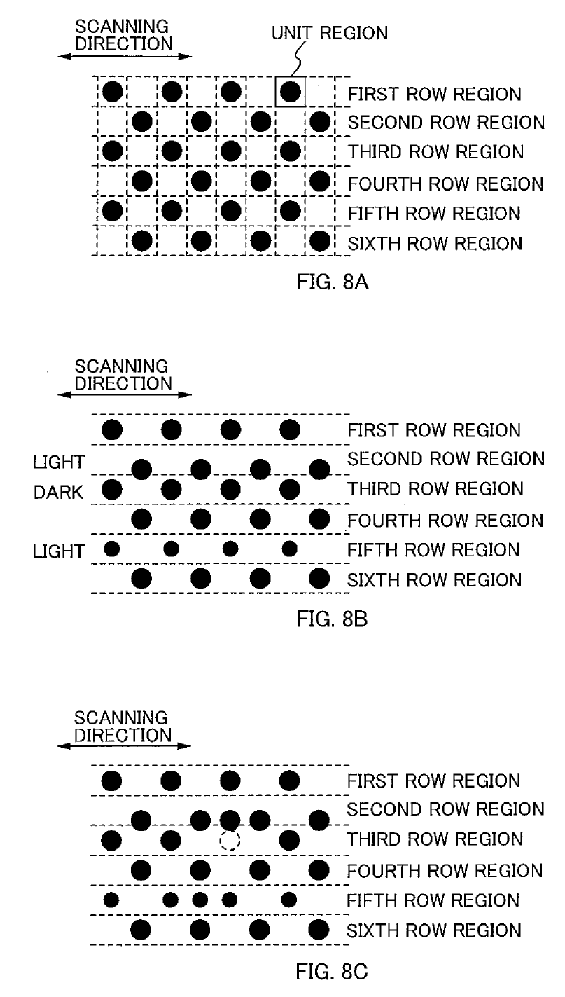

First, the density unevenness is described with reference to FIGS. 8A and 8B. FIG. 8A is a diagram showing a state of raster lines that have been formed ideally. FIG. 8B is a diagram showing a state of raster lines when density unevenness occurs. Note that, for convenience of explanation, an example is described below in which density unevenness occurs an image printed with monochrome printing.

In each of dot-row forming processes, when a certain amount of ink (ink droplet) ejected from a nozzle lands on an ideal landing position, a raster line in each dot-row forming process is formed exactly in a row region as shown in FIG. 8A. However, actually, because of variation in manufacturing accuracy of the nozzles and the like, an ink droplet sometimes lands on a position that is out of the ideal landing position. In an example shown in FIG. 8B, a raster line formed in a second row region is formed being displaced close to a third row region. Also, in the example shown in the figure, an amount of ink ejected to a fifth row region is small, and dots that compose a raster line formed in the fifth row region are small.

As a result, the raster line formed in the second row region is relatively light in density, and the raster line formed in the third row region is relatively dark in density. The raster line formed in the fifth row region is relatively light in density. As this phenomenon is seen macroscopically, a strip-like density unevenness (so-called banding) along the scanning direction appears. The density unevenness of the type described causes deterioration of the quality of a printed image.

### Method for Suppressing Density Unevenness

In order to suppress the above-mentioned density unevenness, it is necessary to obtain density correction values H for correcting the image density, and correct tone values (designated tone values) of pixel data based on the density correction values H. In other words, it can be said that the density correction values H are correction values used to correct the designated tone values.

It is desirable that the density correction values H are obtained for each raster line, and correction of the designated tone values based on the density correction values H is performed for each raster line. This is because, there are cases where raster lines formed with ink ejected from the same nozzle are different in density if nozzles that eject ink to form raster lines adjacent to those raster lines are different. If each density correction value H is associated with each raster line, the density correction value H reflects a combination of a nozzle that ejects ink to form a certain raster line, and a nozzle that ejects ink to form a raster line adjacent to the certain raster line.

As mentioned above, correcting the designated tone values for each raster line allows occurrence of the density unevenness in an printed image to be effectively suppressed, as shown in FIG. 8C. FIG. 8C is a diagram showing a state of raster lines when the occurrence of the density unevenness is suppressed. That is, for a row region that tends to be visually perceived darker in color, a designated tone value corresponding to its raster line is corrected so as to form the raster line light. On the other hand, for a row region that tends to be visually perceived lighter in color, a designated tone value corresponding to its raster line is corrected so as to form the raster line dark.

The correction of designated tone values (density correcting process) is performed by the printer driver when performing halftoning. Specifically, the printer driver, before performing halftoning, requests the printer 1 to sent density correction values H stored in the memory 53 of the printer 1, and stores the sent density correction values H in a memory 113 on a computer 110 side (see FIG. 1). Thereafter, the printer driver corrects tone values (designated tone values) of pieces of pixel data constituting image data of each color, for each raster line based on the density correction values H.

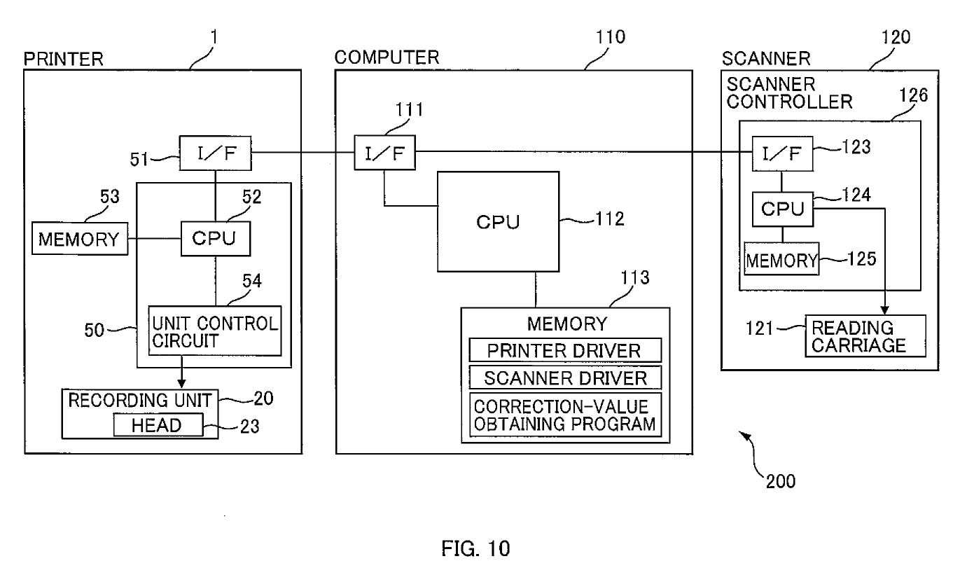

Incidentally, in order to obtain the density correction values H, a correction pattern CP composed of a plurality of raster lines is required to be formed using the printer 1 that needs the density correction, and also the reading density of each of the raster lines of the correction pattern CP (hereinafter referred to as a correction-pattern reading density) is required to be obtained by reading the correction pattern CP with a scanner 120 (for example, see FIG. 10). Based on the correction-pattern reading density of each of the raster lines, the density correction value H of each of the raster lines is obtained. Here, the reading density means the tone value of an image read by the scanner 120 (reading tone value). Besides, in this embodiment, unlike the normal relationship between the reading density and the brightness (the larger the reading density is, the less bright), large reading density means high brightness (bright), and small reading density means low brightness (not bright).

The density correction values H are generally obtained with respect to a target density. Here, the target density has the same value as that of a reading density (outputted tone value) obtained by reading with the scanner 120 a raster line that has been formed ideally based on a certain designated tone value. Accordingly, in the case of the printer 1 that needs the density correction, in order to form a certain raster line to have a desired density, it is necessary to correct the designated tone value of the certain raster line. For correcting the designated tone value of the certain raster line, the density correction value H is obtained using the desired density as the target density.

In order to set the target density, for example, the standard pattern SP is required to be formed on paper using a reference printer, and also the reading density of the standard pattern SP (hereinafter referred to as a standard-pattern reading density) is required to be obtained by reading the standard pattern SP with the scanner 120. Here, the reference printer is a printer that is prepared independently of the printer 1 that needs the density correction. The reference printer is in the same specification as the printer 1, and does not need the density correction because its nozzles are manufactured with high accuracy. It can be said that raster lines constituting the standard pattern SP formed by this reference printer are formed ideally based on the designated tone value with which the standard pattern has been formed. Accordingly, when obtaining the density correction value H for a certain designated tone value, the reading density of the standard pattern formed based on the certain designated tone value can be used as a reading density of a pattern that are ideally formed based on the certain designated tone value.

Then, the density correction value H is obtained based on the correction-pattern reading density with respect to the target density that has been set based on the standard-pattern reading density.

### Problems in Obtaining Density Correction Value H

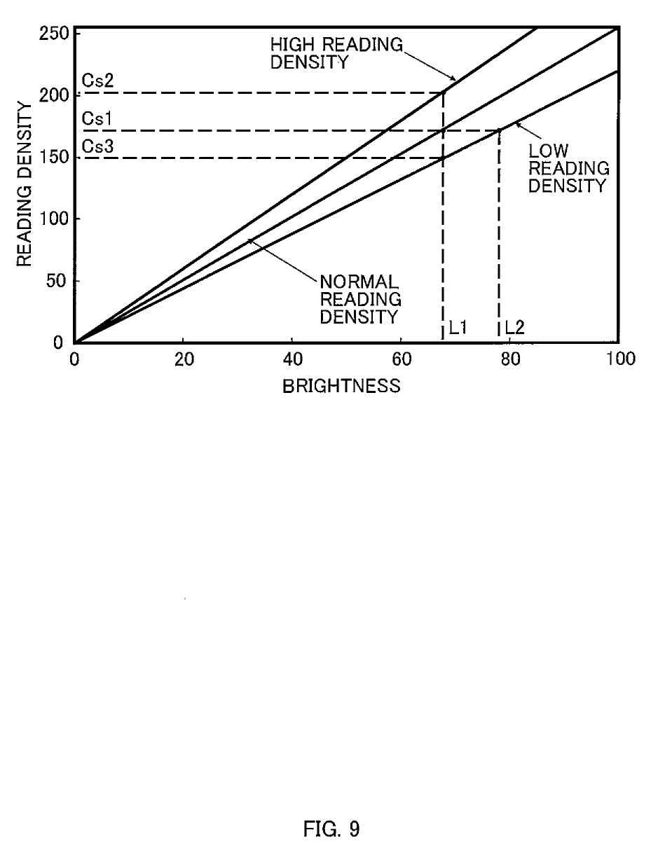

The density correction values H, as mentioned above, are obtained after obtaining the standard-pattern reading densities and the correction-pattern reading densities. Here, there is a possibility that the reading sensitivity with which the scanner 120 reads the standard pattern SP and correction pattern CP fluctuates with time, and that the fluctuation of the reading sensitivity influences the density correction values H. This is described with reference to FIG. 9. FIG. 9 is a graph describing an influence of the fluctuation of the reading sensitivity of the scanner 120. In FIG. 9, the vertical axis indicates the reading density, and the horizontal axis indicates the brightness.

When obtaining the density correction values H, as mentioned above, the standard pattern SP and the correction pattern CP are respectively read by the scanner 120 to obtain the standard-pattern reading densities and the correction-pattern reading densities. When a standard pattern SP having brightness L1 is read by the scanner 120, the reading density of the standard pattern SP is Cs1 as shown in FIG. 9 if the reading sensitivity of the scanner 120 is normal. On the other hand, if the reading sensitivity of the scanner 120 fluctuates to be higher than the reading sensitivity in the normal condition, even in the case of the standard pattern SP having the same brightness L1, the reading density is Cs2. If the reading sensitivity is lower than in the normal condition, the reading density is Cs3.

There is a possibility that the reading sensitivity of the scanner 120 fluctuates in this manner. Therefore, if the standard pattern SP and the correction pattern CP are read separately, an appropriate density is not set as the target density, and an appropriate density correction value H cannot be obtained.

More specific explanation is given below. A case is described in which while the standard pattern SP is read under the normal condition of the reading sensitivity of the scanner 120, the correction pattern CP is read under a condition that the reading sensitivity is lower than in the normal condition. Also, a case is described below in which the standard-pattern reading density associated with brightness L1 is set as the target density.

In the above-mentioned case, as a matter of course, it is necessary to set, as the target density, a standard-pattern reading density (Cs3) obtained with a reading sensitivity with which the correction pattern CP is read, that is, a reading sensitivity that is lower than in the normal condition. However, in the above-mentioned case, there is a possibility that a standard-pattern reading density (Cs1) obtained when the standard pattern SP is read is set as the target density. As a result, the standard-pattern reading density obtained with the normal reading sensitivity is set as the target density, and the density correction value H is obtained based on the correction-pattern reading density obtained with the reading sensitivity that is lower than in the normal condition. In performing the density correction with such a density correction value H, the density Cs1, which is higher than the density Cs3 that should be set as the target density, is set as the target density. As a result thereof, the density correction is performed aimed at brightness L2, which is higher than brightness L1 corresponding to the target density to be aimed, as shown in FIG. 9.

Regarding the problems described above, in this embodiment, it is possible to obtain the density correction values H without being influenced by the fluctuation of the reading sensitivity of the scanner 120. In the next section, a correction-value obtaining process of this embodiment is described.

### Correction-Value Obtaining Process

The correction-value obtaining process is for forming the correction pattern CP, obtaining the respective reading densities of the correction pattern CP and the standard pattern SP by the scanner 120, obtaining density correction values H from their respective reading densities, and storing the density correction values H in the memory 53 of the printer 1 that is to undergo the correction-value obtaining process. The correction-value obtaining process is performed in an inspection process of the printer 1, in a correction-value obtaining system 200 constructed at a printer manufacturing factory, for example.

### Correction-Value Obtaining System 200

First, the overall configuration of the correction-value obtaining system 200 is described with reference to FIG. 10. FIG. 10 is a block diagram showing the configuration of the correction-value obtaining system 200.

The correction-value obtaining system 200 includes: the printer 1 that is to undergo the correction-value obtaining process and forms a correction pattern CP; the computer 110 placed in an inspection line; and the scanner 120. Descriptions of the configuration of the printer 1, etc. are omitted because they are mentioned above.

The computer 110 is communicably connected to the printer 1 and the scanner 120 through the interface 111. In the memory 113 of the computer 110, a program for obtaining correction values is stored. The correction-value obtaining program is a program for calculating the density correction values H by performing image processing or analysis of image data sent from the scanner 120, and is performed by a CPU 112 of the computer 110. Note that, in addition to the correction-value obtaining program, a printer driver for making the printer 1 print the correction pattern CP, and a scanner driver for controlling the scanner 120 are stored in the memory 113.

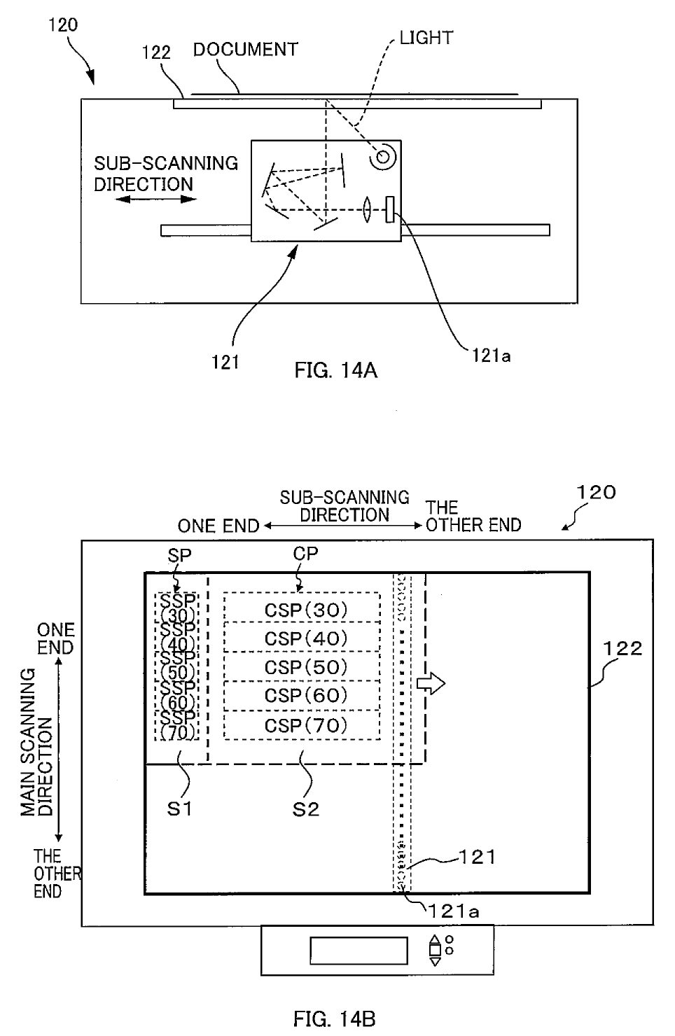

The scanner 120 includes an elongated reading carriage 121 having a plurality of built-in reading sensors 121a (see FIG. 14B). The scanner 120 reads the image of a document placed on a document platen glass 122 (see FIG. 14B) with the reading sensors 121a of the reading carriage 121, and obtains the image data of the image (that is, the reading density of the image). This image data represents the reading density (reading tone value) for each pixel in the image. In this embodiment, the scanner 120 is used to read the standard pattern SP and correction pattern CP, and to obtain the standard-pattern reading densities and correction-pattern reading densities. Beside, the scanner 120 includes a scanner controller 126 consisting of an interface 123, a CPU 124, and a memory 125, and sends image data to the scanner driver of the computer 110 through the interface 123. Note that the scanner 120 of this embodiment reads an image with a reading resolution higher than the print resolution of the image.

### Procedures of Correction-Value Obtaining Process

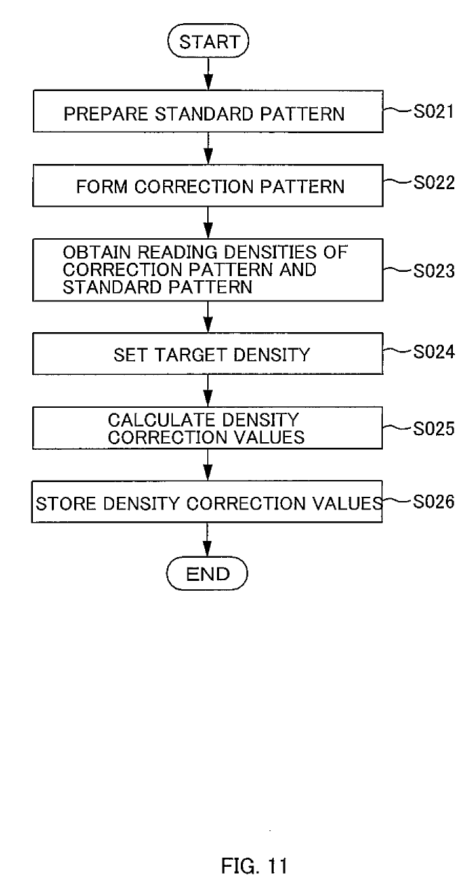

Next, procedures of the correction-value obtaining process are described with reference to FIG. 11. FIG. 11 is a flowchart of the correction-value obtaining process. Note that, in the case where the printer 1 capable of multi-color printing is to undergo the process, the correction-value obtaining process is performed for each color of ink with the same procedures. Therefore, the correction-value obtaining process regarding a certain color of ink (e.g., cyan) is described below.

The correction-value obtaining process starts from preparation of the standard pattern SP (S021), as shown in FIG. 11. Next, a correction pattern CP is formed using the printer 1 that is to undergo the correction-value obtaining process (S022). The correction pattern CP and standard pattern SP are then read by the scanner 120, and the correction-pattern reading densities and standard-pattern reading densities are obtained (S023). Then, the target density is set based on the standard-pattern reading densities (S024). Next, with respect to the set target density, the density correction values H are obtained based on the correction-pattern reading densities (S025). The obtained density correction values H are stored in the memory 53 of the printer 1 (S026). This results in the density correction values H that are stored in the memory 53 of the printer 1 reflecting density unevenness characteristics of the printer 1. Hereinbelow, procedures in the correction-value obtaining process are described.

### Preparation of Standard Pattern SP

The standard pattern SP is a pattern that is formed on a predetermined paper (hereinafter referred to as a standard sheet S1) using a reference printer before the correction-value obtaining process. An inspector, when performing the correction-value obtaining process, prepares the standard pattern SP. Note that, the standard pattern SP is formed in the same procedures as the above-mentioned printing process, based on print data that is sent from a printer driver installed in a computer connected to the reference printer.

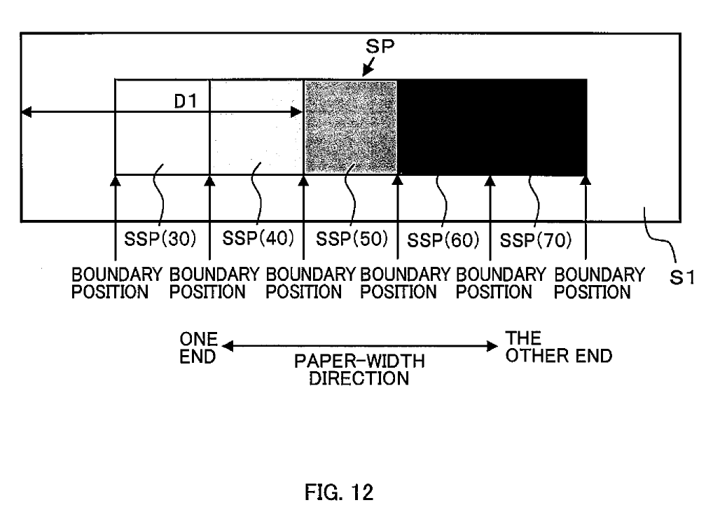

The standard pattern SP is described with reference to FIG. 12. FIG. 12 is an explanatory diagram of the standard pattern SP. The arrow in FIG. 12 indicates a paper-width direction of the standard sheet S1.

The standard pattern SP, as shown in FIG. 12, consists of five standard sub-patterns SSP that are different in density from each other. The standard sub-patterns SSP are each a pattern in a short strip shape, and are formed based on image data of their respective uniform tone values. Here, the tone value corresponds to the designated tone value (designated density), and in FIG. 12, the standard sub-patterns SSP are arranged from left to right in ascending order of darkness: designated tone value 76 (designated density 30%) , 102 (40%), 128 (50%) , 153 (60%), and 179 (70%). Note that these five designated tone values are respectively expressed by symbols Sa (=76), Sb (=102), Sc (=128), Sd (=153), and Se (=179). Besides, for example, the standard sub-pattern SSP printed with the designated tone value Sa is represented by a symbol SSP(30), as shown in FIG. 12.

As shown in FIG. 12, the standard sub-patterns SSP have the same width in the paper-width direction of the standard sheet S, and are arranged contacting adjacent to each other. Besides, the positions where the standard sub-patterns SSP are each formed in the standard sheet S1 are predetermined. Therefore, when the standard pattern SP is formed on the standard sheet S1, the boundary position of each of the standard sub-patterns SSP in the paper-width direction is located at a position predetermined by taking one end (the left end) in the paper-width direction of the standard sheet S1 as a reference.

### Formation of Correction Pattern CP

The correction pattern CP is formed on a predetermined paper (hereinafter referred to as a correction sheet S2) using the printer 1 that is to undergo the correction-value obtaining process. This correction pattern CP is formed by the controller 50 of the printer 1 in the same procedures as the above-mentioned printing process, based on print data that is sent from the printer driver of the computer 110. In terms of this meaning, it can be said that the controller 50 of the printer I form the correction pattern CP.

The correction pattern CP of this embodiment is composed of a plurality of dot rows extending along the predetermined direction (that is, raster lines formed along the moving direction of the head 23) that are lined up in a direction intersecting the predetermined direction (the transporting direction). Note that, in this embodiment, the print resolution is 720 dpi in the transporting direction. In other words, a plurality of raster lines constituting the correction pattern CP are lined up at an interval of 1/720 inch.

First, the correction sheet S2 of this embodiment is described. The correction sheet SP is a sheet of paper different from the standard sheet S1 on which the standard pattern SP is formed (that is, a sheet of paper prepared independently of the standard sheet S1) For example, in the case where a plurality of printers exist as printer 1 that is to undergo the correction-value obtaining process, the correction pattern CP is formed at every correction-value obtaining process (for every printer). On the other hand, the standard pattern SP does not have to be formed for each correction-value obtaining process. If the correction sheet S2 and the standard sheet S1 on which the standard pattern SP is formed are prepared independently in such a manner as this embodiment, it is possible to repeatedly use the standard sheet S is formed. Therefore, it is possible to omit to form the standard pattern SP every time the correction-value obtaining process is performed.

Besides, the correction sheet S2 is the same type of paper as the standard sheet S1. In addition, ink used in forming the correction pattern CP is the same type of ink as used in forming the standard pattern SP.

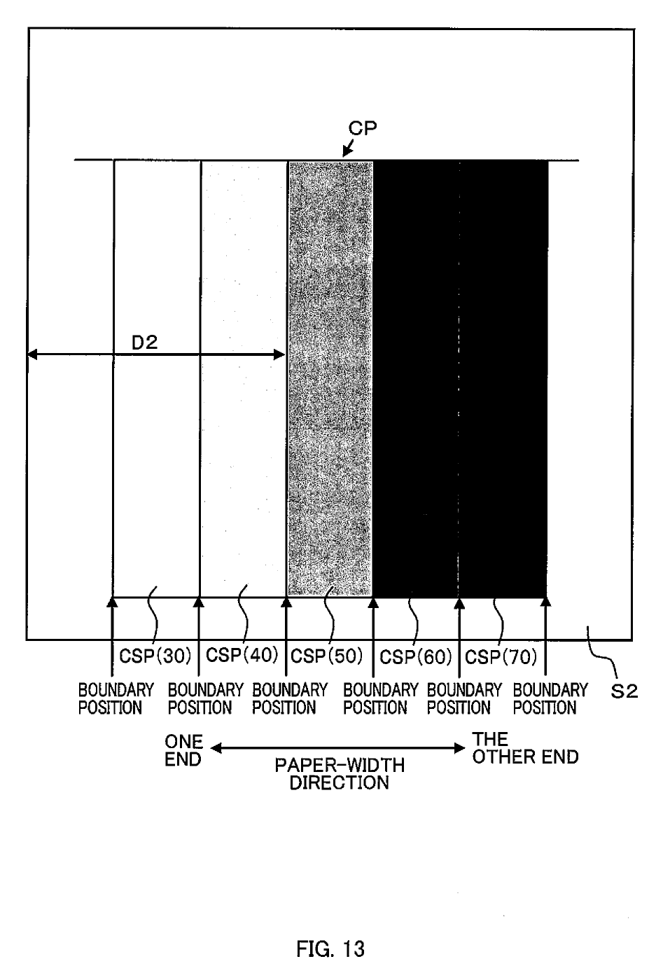

The correction pattern CP is described below with reference to FIG. 13. FIG. 13 is an explanatory diagram of the correction pattern CP. The arrow in FIG. 13 indicates a paper-width direction of the correction sheet S2.

The correction pattern CP, as shown in FIG. 13, consists of five band-shaped correction sub-patterns CSP that are different in density from each other. That is, in this embodiment, based on five designated tone values different from each other, the correction pattern CP including the five correction sub-patterns CSP that are different in density is formed on the correction sheet S2.

Besides, in the correction pattern CP in this embodiment, each of the correction sub-patterns CSP mates with any one of the standard sub-patterns SSP, and the correction sub-pattern CSP and standard sub-pattern SSP that mate with each other are formed so as to have the same density. Specifically, in FIG. 13, the correction sub-patterns CSP are arranged from left to right in ascending order of darkness: designated tone value 76 (designated density 30%), 102 (40%), 128 (50%), 153 (60%) and 179 (70%). In other words, an n-th correction sub-pattern CSP from the left in the correction pattern CP mates with an n-th standard sub-pattern SSP from the left in the standard pattern SP, and is formed with the same designated tone value (designated density) as the n-th standard sub-pattern SSP from the left. Here, for example, the correction sub-pattern CSP that mates with the standard sub-pattern SSP(30) printed with the designated tone value Sa is represented by a symbol CSP(30), as shown in FIG. 13.

As shown in FIG. 13, the correction sub-patterns CSP(30), CSP(40), CSP(50), CSP(60), CSP(70) are arranged contacting adjacent to each other in the paper-width direction of the correction sheet S2. Besides, each of the correction sub-patterns CSP(30), CSP(40), CSP(50), CSP(60), CSP(70) consists of a plurality of raster lines lined up in the transporting direction. More specifically, each of the correction sub-patterns CSP(30), CSP(40), CSP(50), CSP(60), CSP(70) is formed by front-end printing, regular printing, and rear-end printing, and consists of raster lines formed by front-end printing, raster lines formed by regular printing, and raster lines formed by rear-end printing. The plurality of raster lines constituting each correction sub-pattern CSP are lined up at an interval of 1/720 inch.

Further, as shown in FIG. 13, the correction sub-patterns CSP(30), CSP(40), CSP(50), CSP(60), CSP(70) has the same width in the paper-width direction. Particularly, in this embodiment, the width of the correction sub-patterns CSP(30), CSP(40), CSP(50), CSP(60), CSP(70) in the paper-width direction is equal to the width of the standard sub-patterns SSP(30), SSP(40), SSP(50), SSP(60), SSP(70) in the paper-width direction.

The positions where the correction sub-patterns CSP(30), CSP(40), CSP(50), CSP(60), CSP(70) are each formed in the correction sheet S2 are predetermined. Therefore, boundary position of each of the correction sub-patterns CSP(30), CSP(40), CSP(50), CSP(60), CSP(70) in the paper-width direction is located at a position predetermined by taking one end (the left end) in the paper-width direction of the correction sheet S2 as a reference. In this embodiment, the correction pattern CP is formed in such a manner as a distance from the left end of the standard sheet S1 to the boundary position of the n-th standard sub-pattern SSP (e.g., distance D1 in FIG. 12) is equal to a distance from the left end of the correction sheet S2 to the boundary position of the n-th correction sub-pattern CSP, which is a correction sub-pattern CSP mating with the n-th standard sub-pattern SSP (distance D2 in FIG. 13).

### Obtainment of Reading Densities

By reading the correction pattern CP and standard pattern SP with the scanner 120 of the correction-value obtaining system 200, the correction-pattern reading densities and standard-pattern reading densities are obtained. Hereinbelow, reading of the correction pattern CP and standard pattern SP by the scanner 120 is described with reference to FIGS. 14A and 14B.

FIG. 14A is a schematic view showing the internal configuration of the scanner 120. The arrow in FIG. 14A indicates a direction in which the reading carriage 121 moves (sub-scanning direction). Note that the dashed line in FIG. 14A indicates the path of light when reading an image. FIG. 14B is a diagram showing how the scanner 120 reads the correction pattern CP and the standard pattern SP. The arrows in FIG. 14B indicate a direction in which the reading sensors 121a are lined up (main scanning direction) and the sub-scanning direction. Note that, in FIG. 14B, the reading sensors 121a are shown in a different scale from other items.

First, with reference to FIG. 14A, a reading process by the scanner 120 is briefly described. The scanner 120 irradiates light onto a document placed on the document platen glass 122, and reads an image of the document by detecting the reflected light with the reading sensor 121a disposed on the reading carriage 121. Thereby, the image data (reading density) of the image is obtained.

A plurality of the reading sensors 121a, which are each composed of a photodiode and CCD, are provided in the reading carriage 121. The plurality of reading sensors 121a are lined up in a line in the longitudinal direction of the reading carriage 121 (in FIG. 14A, a direction substantially normal to the surface of the paper on which the figure is described). During the reading process, inside the scanner 120, while the reading carriage 121 is moving in a direction (sub-scanning direction) normal to its longitudinal direction, each of the reading sensors 121a that moves together with the reading carriage 121 detects the reflected light from the document. At this stage, one of the plurality of reading sensors 121a reads an image (image piece) located at the same position in the main scanning direction as this reading sensor 121a. In other words, a reading sensor 121a reads a section, in the image of the document, that is located at the same position in the main scanning direction.

By the above-mentioned reading process, reading of the correction pattern CP and standard pattern SP is performed. As shown in FIG. 14B, in this embodiment, when reading the correction pattern CP and standard pattern SP, the standard sheet S1 is placed on the document platen glass 122 in such a manner as the upper end of the standard sheet S1 is aligned with one end of the document platen glass 122 in the sub-scanning direction, and then the correction sheet S2 is placed on the document platen glass 122 adjacent to the standard sheet S1 in such a manner as the upper end of the correction sheet S2 is aligned with the lower end of the standard sheet S1. Thereby, the scanner 120 reads both of the correction pattern CP and the standard pattern SP in a single reading process.

As a result, the image data of the standard pattern SP is obtained together with the image data of the correction pattern CP. More specifically, the image data of each of the standard sub-patterns SSP in the standard pattern SP is obtained together with the image data of each of the correction sub-patterns CSP in the correction pattern CP. That is, the reading density of each of the standard sub-patterns SSP (hereinafter referred to as a standard-sub-pattern reading density) is obtained together with the reading density of each of the correction sub-patterns CSP (hereinafter referred to as a correction-sub-pattern reading density).

Note that, as mentioned above, the scanner 120 reads the image with a reading resolution higher than the print resolution of the image. More specifically, the reading resolution of the scanner 120 in the sub-scanning direction is higher than a spacing between raster lines constituting each of the correction sub-patterns CSP (720 dpi) In resolution conversion to be performed later, the image data of each of the correction sub-patterns CSP is converted into an image having a resolution with which the correction sub-pattern CSP is formed. Then, an image data (reading density) corresponding to that resolution is obtained. That is, in this embodiment, the correction-sub-pattern reading density of each of the correction sub-patterns CSP is obtained for each raster line.

Besides, when placing the standard sheet S1 and correction sheet S2 on the document platen glass 122, it is desirable that these two sheets are placed in such a manner as the left ends of both of the sheet S1 and sheet S2 is aligned with one end of the document platen glass 122 in the main scanning direction as shown in FIG. 14B. In this case, the distance from the left end of the standard sheet S1 to the boundary position of the n-th standard sub-pattern SSP is equal to the distance from the left end of the correction sheet S2 to the boundary position of the n-th correction sub-pattern CSP, as mentioned above. Therefore, as shown in FIG. 14B, the standard sub-pattern SSP and correction sub-pattern CSP that mate with each other are placed so as to be located at the same position in the main scanning direction, that is, in a direction in which the reading sensors 121a are lined up. Accordingly, the mated standard sub-pattern SSP and correction sub-pattern CSP are read by the same reading sensor 121a, of the plurality of reading sensors 121a lined up in the main scanning direction. Note that, the positions of the mated standard sub-pattern SSP and correction sub-pattern CSP in the main scanning direction does not have to be completely the same, as long as both of the sub-patterns can be read by the same reading sensor 121a.

### Setting Target Density

In the correction-value obtaining system 200, when the image data of the standard pattern SP and the image data of the correction pattern CP have been received on the computer 110 side, the correction-value obtaining program calculates the density correction values H. The correction-value obtaining program, when calculating the density correction values H, sets the target density based on the standard-pattern reading density.

More specifically, the correction-value obtaining program first extracts the image data of the standard pattern SP from pieces of the image data that has been sent from the scanner 120. After extracting the image data of the standard pattern SP, the correction-value obtaining program divides the image data of the standard pattern SP into the image data of the standard sub-pattern SSP. Note that extracting the image data of the standard pattern SP and dividing it into the standard sub-patterns SSP can be realized with publicly known technologies for image processing.

Thereafter, the correction-value obtaining program converts the resolution of the image data of each of the standard sub-patterns SSP, from the resolution when being read by the scanner 120 to the print resolution. Then, for the image data of each standard sub-pattern SSP whose resolution has been converted, the pixel density (tone value) is calculated for each of pixels constituting the image data.

When densities of all pixels have been calculated for the image data of each standard sub-pattern SSP, the correction-value obtaining program calculates the average density for the all pixels. This average density is a density indicating the standard-sub-pattern reading density of each of the standard sub-patterns SSP.

In this embodiment, the standard-sub-pattern reading density of each standard sub-pattern SSP is set as the target density. Besides, the target density is set for each standard sub-pattern SSP, and the standard-sub-pattern reading density is set as a target density of the corresponding standard sub-pattern SSP. Accordingly, in this embodiment, the density correction values H are obtained using the standard-sub-pattern reading densities as the target densities.

### Calculation of Density Correction Values H

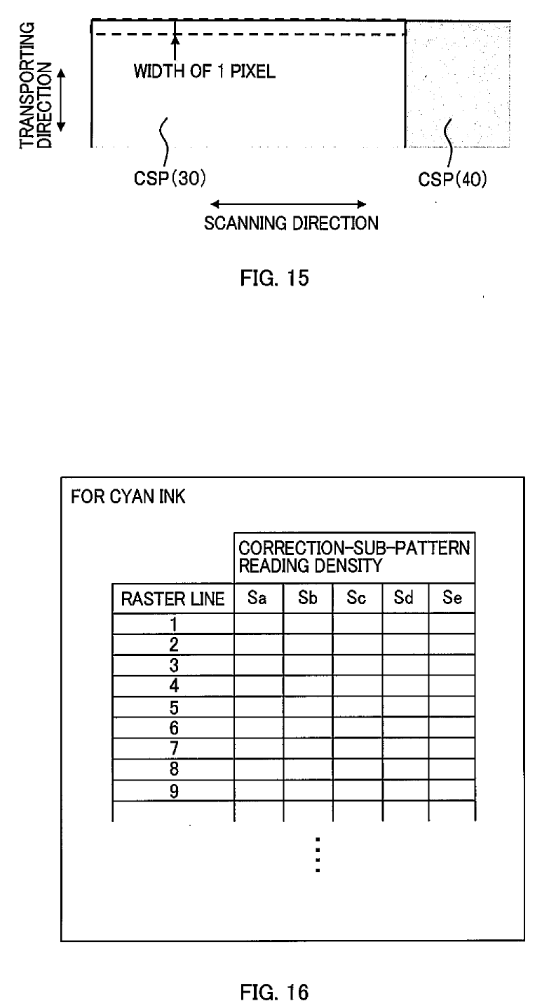

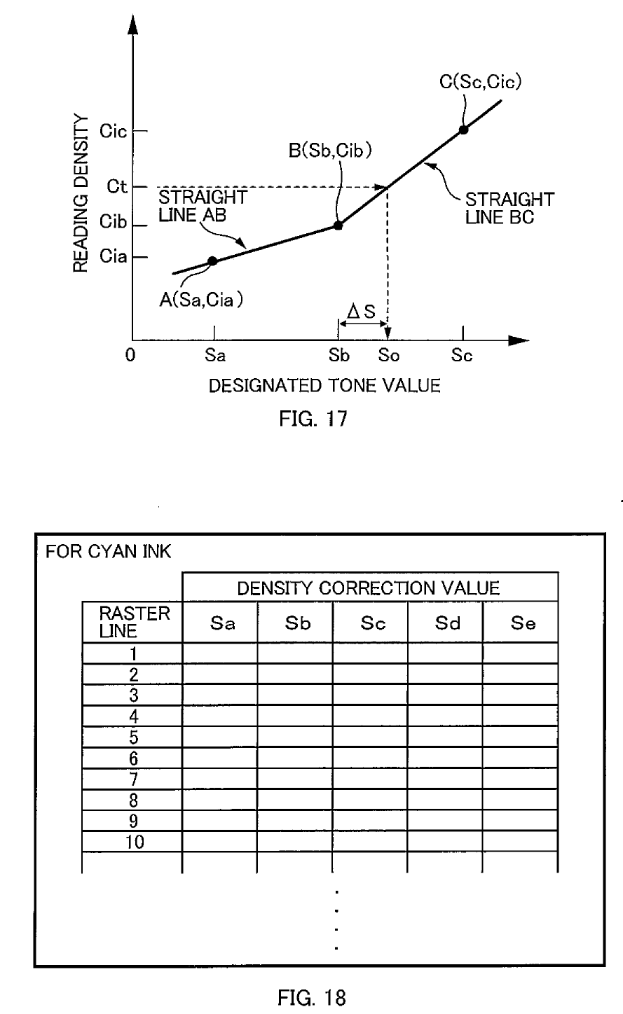

After setting the target density, the density correction value H is obtained for each raster line by the correction-value obtaining program based on the correction-sub-pattern reading density. With reference to FIGS. 15 and 17, calculation of the density correction values H is described below. FIG. 15 is a diagram showing the image data of the correction sub-patterns CSP. The arrows in FIG. 15 indicate the scanning direction and the transporting direction. FIG. 16 is a diagram showing a reading-density table of the reading densities for each raster line of the correction sub-pattern CSP. FIG. 17 is an explanatory diagram of procedures for obtaining the density correction values H.

First, in the same way as the standard pattern SP, after extracting the image data of the correction pattern CP, the image data is divided into the image data of the correction sub-pattern CSP. The image data of the correction sub-pattern CSP undergoes resolution conversion by the correction-value obtaining program to be converted into print resolution.

Thereafter, for each raster line in the image data of each of the standard sub-patterns SSP, the density of a pixel row corresponding to the raster line is calculated. More specifically, for example, of raster lines constituting the correction sub-pattern CSP(30) formed with the designated tone value Sa, the raster line located at the top corresponds to the pixel row located at the top (area surrounded by dashed lines in FIG. 15). The densities of all pixels constituting this pixel row are calculated; the average density of all the pixels is defined as the density of the pixel row. The density of a certain pixel row is the density indicates the reading density (correction-sub-pattern reading density) of a raster line corresponding to the certain pixel row. Calculating densities of the pixel rows is performed for each correction sub-pattern CSP. In other words, calculating the densities is performed for each designated tone value that is used in forming each correction sub-pattern CSP.

As a result thereof, in the memory 113 of the computer 110, a reading density table, shown in FIG. 16, is created that has reading densities for each raster line of each of the correction sub-patterns CSP (in other words, designated tone values used in forming their respective correction sub-patterns CSP).

Next, with the correction-value obtaining program, the density correction value H is obtained for each raster line using the standard-sub-pattern reading density as the target density, based on the correction-sub-pattern reading density. The density correction value H for each raster line is obtained, using the standard-sub-pattern reading density of one of the plurality of standard sub-patterns SSP as the target density, with respect to the designated tone value used in forming a correction sub-pattern CSP that mates with that standard sub-pattern SSP. Further, at this stage, the density correction value H is obtained based on the correction-sub-pattern reading density of the correction sub-pattern CSP that mates with that standard sub-pattern SSP, and the correction-sub-pattern reading density of at least one of correction sub-patterns CSP other than the correction sub-pattern CSP that mate with that standard sub-pattern SP.

For specific explanation, an example is described below in which the standard-sub-pattern reading density of the standard sub-pattern SSP(40) formed with the designated tone value Sb is used as the target density.

In the case where the standard-sub-pattern reading density of the standard sub-pattern SSP(40) is set as the target density, the density correction value H is obtained based on the following correction-sub-pattern reading densities: the correction-sub-pattern reading density of the correction sub-pattern CSP(40), which mates with the standard sub-pattern SSP(40); the correction-sub-pattern reading density of the correction sub-pattern CSP(30), which is formed based on the designated tone value Sa that is closest to the designated tone value Sb among designated tone values smaller than Sb; and the correction-sub-pattern reading density of the correction sub-pattern CSP (50), which is formed based on designated tone value Sc that is closest to the designated tone value Sb among designated tone values larger than the Sb.

More specifically, the density correction value H is obtained based on the correspondences between designated tone values and correction-pattern reading densities in the correction sub-patterns CSP(30), CSP(40), CSP(50). Here, the correction-sub-pattern reading density of a certain raster line i of the correction sub-patterns CSP(30), CSP(40), CSP(50) is defined as Cia, Cib, and Cic. Besides, the standard-sub-pattern reading density of the standard sub-pattern SSP(40), that is, the target density is defined as Ct.

If in a certain raster line i of raster lines constituting the correction sub-pattern CSP(40), the correction-sub-pattern reading density Cib is lower than the target density Ct, the certain raster line i is formed lighter than a line formed with the target density Ct. Therefore, it can be considered that the correction so as to make its designated tone value larger is suitable. In such a case, a designated tone value So corresponding to the target density Ct is obtained based on correspondences between designated tone values Sb, Sc and correction-pattern reading densities Cib, Cic in the correction sub-patterns CSP (40), CSP (50). More specifically, as shown in FIG. 17, the designated tone value So corresponding to the target density Ct is obtained using linear approximation with the following expression based on the correspondence (Sb, Cib), (Sc, Cic) of the respective designated tone values and correction-sub-pattern reading densities in the correction sub-patterns CSP (40), CSP (50).

So=Sb+(Sc−Sb)/((Cic−Cib)/(Ct−Cib))

Then, the density correction value H with respect to the target density Ct for the certain raster line i is obtained with the following expression based on the designated tone value So and the designated tone value Sb of the correction sub-pattern CSP(40).

i H=ΔS/Sb=(So−Sb)/Sb

On the other hand, if in the certain raster line i, a correction-sub-pattern reading density Cib is higher than the target density Ct, the certain raster line i is formed darker than a line formed with the target density Ct. Therefore, it can be considered that the correction so as to make its designated tone value smaller is suitable. In such a case, the designated tone value So corresponding to the target density Ct is obtained using linear approximation with the following expression based on the correspondence (Sa, Cia), (Sb, Cib) of the respective designated tone values and correction-sub-pattern reading densities in the correction sub-patterns CSP(30), CSP(40). Then, with the above-mentioned expression, the density correction value H with respect to the target density Ct for the certain raster line i is obtained.

So=Sb+(Sb−Sa)/((Cib−Cia)/(Ct−Cib))

As mentioned above, the density correction value H for the target density to which the reading density of the standard sub-pattern SSP(40) is set is obtained for each raster line. In similar procedures thereto, the density correction values H for the target densities to which the respective reading densities of the standard sub-patterns SSP(30), SSP(50), SSP(60), SSP(70) are set are obtained for each raster line.

Note that, in the case where the reading density of the standard sub-pattern SSP(30) is set as the target density, if the correction-sub-pattern reading density of a certain raster line i in the correction sub-pattern CSP(30) is higher than the target density, the density correction value H is obtained using so-called extrapolation based on the correspondences between the respective designated tone values and reading densities of the certain raster line i of the correction sub-patterns CSP (30), CSP (40). Further, in the case where the reading density of the standard sub-pattern SSP(70) is set as the target density, if the correction-sub-pattern reading density of a certain raster line i in the correction sub-pattern CSP(70) is lower than the target density, the density correction value H is obtained using extrapolation based on the correspondences between the respective designated tone values and reading densities of the certain raster line i of correction sub-patterns CSP(60), CSP(70).

### Storing Density Correction Values H

When calculation of the density correction values H are completed, the correction-value obtaining program sends the density correction values H from the computer 110 to the printer 1 and stores them in the memory 53 of the printer 1.

As a result, a correction-value table, shown in FIG. 18, of the density correction values H obtained for the respective raster lines is created in the memory 53 of the printer 1. That is, each density correction value H is made to be associated with each raster line and stored in the memory 53. Besides, as shown in FIG. 18, the density correction values H are stored for the respective designated tone values Sa, Sb, Sc, Sd, Se of the correction sub-patterns CSP. This is because the density correction value H is obtained for the designated tone value of each correction sub-pattern CSP as a result that the respective reading densities of the standard sub-patterns SSP are set as the target densities and then the density correction values H are each obtained for the designated tone value of each of the correction sub-patterns CSP that mates with the respective standard sub-patterns SSP. Note that, FIG. 18 is an explanatory diagram of the correction-value table.

After the density correction values H are stored in the memory 53 of the printer 1, the correction-value obtaining process has completed. Thereafter, the printer 1 is disconnected from the computer 110 and undergoes other inspections of the printer 1. Then, the printer 1 is shipped from the factory.

### Density Correcting Process

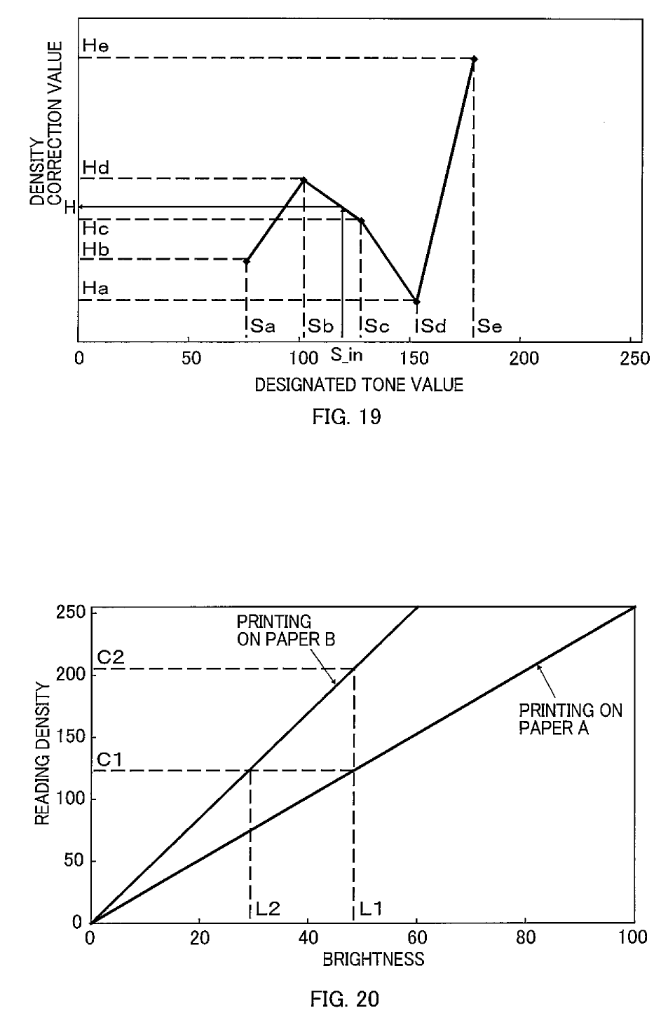

When a user who has the printer 1 including the memory 53 stored the density correction values H makes the printer 1 perform printing process, the printer driver of a computer 110 connected to the printer 1 reads the density correction values H from the memory 53, and performs the density correcting process for correcting the designated tone values using the density correction values H, as mentioned above. The density correcting process is described below more specifically with reference to FIG. 19. FIG. 19 is an explanatory diagram of the density correcting process. Note that, for convenience of explanation, the density correcting process in monochrome printing of an image is described below.

In the density correcting process, when an image is printed by a user, designated tone values of the image data of the image are corrected for each of raster lines, using the density correction values H associated with the respective raster lines. More specifically, if for example, the designated tone value S_in of a certain raster line i of the image data is the same as any one of the designated tone values Sa, Sb, Sc, Sd, Se of the correction sub-patterns CSP, the designated tone value S_in of the certain raster line i is corrected with the density correction value H of that designated tone value. A designated tone value S_out of the certain raster line i after correction is S_in x (1+H).

On the other hand, if the designated tone value S_in of a certain raster line i is different from any of the designated tone values Sa, Sb, Sc, Sd, Se of the correction sub-patterns CSP, a density correction value H for that designated tone value S_in is obtained with linear interpolation shown in FIG. 19. Based on the obtained density correction value H, a corrected tone value S_out (=S_in×(1+H)) is obtained. Note that, in FIG. 19, the density correction values Ha, Hb, Hc, Hd, He are density correction values that are associated with a certain raster line i and are respectively for the designated tone values Sa, Sb, Sc, Sd, Se.

### Effectiveness of This Embodiment

In this embodiment, in the correction-value obtaining process, both of the standard pattern SP and the correction pattern CP are simultaneously read with the scanner 120 in a single reading process. Accordingly, the correction-pattern reading densities of the correction pattern CP are obtained, with the same reading sensitivity as the standard-pattern reading densities of the standard pattern SP is obtained. Therefore, it is possible to resolve the above-mentioned problem caused by the difference between the reading sensitivity in reading the correction pattern CP and the reading sensitivity in reading the standard pattern SP.

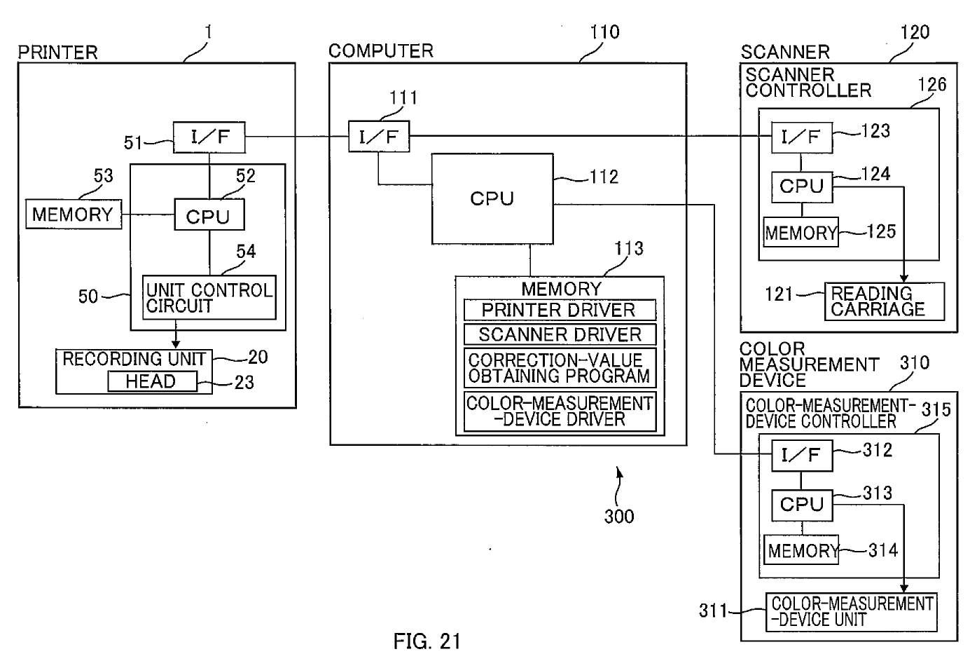

In addition, in this embodiment, the standard sheet S1 and the correction sheet S2 are the same type of paper, and an ink used in printing the standard pattern SP and an ink used in forming the correction pattern CP are the same type of ink. As a result, it is possible to avoid the influence on the density correction values H from the difference of the types of a medium and liquid that are used in forming the standard pattern SP and correction pattern CP. This is described with reference to FIG. 20. FIG. 20 is an explanatory diagram describing the influence in the case where the standard pattern SP and correction pattern CP are formed on different types of paper from each other. In FIG. 20, the vertical axis indicates reading density, and the horizontal axis indicates brightness.

In the case where a certain image is printed on paper A and paper B whose types are different, color values in the printed image on both types of paper (e.g., brightness) are measured by a color measurement device 310 (to be described later), suppose that the measurement results of both papers are the same (e.g., both of the measured brightnesses are L1). In such a case, when the images on both sheets of paper are read by the scanner 120 with a certain reading sensitivity as shown in FIG. 20, there is a possibility that even if images having the same brightness L1 are read, different reading densities (density C1, C2 in FIG. 20) are obtained (so-called metamerism).

In other words, if printing mediums vary, there is a possibility that even if the reading densities are the same, the color measuring values are different. For example, in the case where the standard pattern SP is formed on paper A and the correction pattern CP is formed on paper B, there is a possibility that while the standard-pattern reading density and the correction-pattern reading density are the same, the measured brightnesses, which are color measuring values, are different. In such a case, if the density correction values H are obtained based on the correction-pattern reading densities using the standard-pattern reading densities as the target densities, there is a risk that the densities is appropriately not corrected. That is, in the case where correction is performed aimed at realizing designated tone values corresponding to the target densities, there are cases where when an image is printed based on the corrected designated tone values, an image having a brightness different from a desired one is printed (in the example of FIG. 20, when printing an image to have brightness L1, an image is printed with brightness L2 lower than brightness L1) This problem can similarly occur when an ink used in forming the standard pattern SP and an ink used in forming the correction pattern CP are different.

In contrast, in this embodiment, between the standard pattern SP and correction pattern CP, the types of a medium and liquid that are used in forming patterns are the same, it is possible to avoid the occurrence of the above-mentioned problem.

Further, in this embodiment, the standard pattern SP and correction pattern CP are read with the standard sub-pattern SSP and correction sub-pattern CSP that mate with each other being located the same position in the main scanning direction. In other words, the standard sub-pattern SSP and correction sub-pattern CSP that mate with each other are read, of the plurality of reading sensors 121a, by the same reading sensor 121a. As a result, it is possible to suppress reading the mated standard sub-pattern SSP and correction sub-pattern CSP with different reading sensitivities, due to variation in reading sensitivity among the reading sensors 121a.

Note that as another method for locating the mated standard sub-pattern SSP and correction sub-pattern CSP at the same position in the main scanning direction, it can be considered to prepare the standard sheet S1 on which an opening having the same size and shape as the correction pattern CP is formed and form the standard pattern SP upstream of the opening of the standard sheet S1 in the sub-scanning direction, for example. Then, when the standard sheet S1 and correction sheet S2 are placed on the document platen glass 122 of the scanner 120, the standard sheet S1 is first placed on the document platen glass 122, and the correction sheet S2 is placed on the document platen glass 122 over the standard sheet S1 so as to be aligned with the opening. This method also enables the mated standard sub-pattern SSP and correction sub-pattern CSP to be located at the same position in the main scanning direction.

### FIRST MODIFIED EXAMPLE

In the above-mentioned embodiment, the correction pattern CP is formed so that its correction sub-patterns CSP each mate with any of the standard sub-patterns SSP and the correction sub-pattern CSP and standard sub-pattern SSP that mate with each other have the same density. However, it is not necessary to form the correction pattern CP in the same say as the above-mentioned embodiment. Therefore, an example (hereinafter referred to as the first modified example) can be considered that is different from the above-mentioned embodiment (hereinafter referred to as the present example). Hereinbelow, the correction-value obtaining process of the first modified example is described.

### Correction-Value Obtaining System 300 of First Modified Example

First, with reference to FIG. 21, a correction-value obtaining system 300 of the first modified example is described. FIG. 21 is a block diagram showing the configuration of the correction-value obtaining system 300 of the first modified example.

The correction-value obtaining system 300 of the first modified example includes the color measurement device 310 in addition to the configuration of the correction-value obtaining system 200 of the present example, as shown in FIG. 21. The computer 110 is communicably connected to the color measurement device 310 through the interface 111, and in the memory 113 of the computer 110, a color-measurement-device driver for controlling the color measurement device 310 is stored.

The color measurement device 310 is a spectrophotometer that measures color values in the certain range of an image with a color measurement unit 311 and obtains the color measuring values of the certain range. In the modified example, the device is used for measuring the respective color value of the standard sub-patterns SSP of the standard pattern SP and obtaining the color measuring values of each of the standard sub-patterns SSP. Note that, in this embodiment, the color values of the standard sub-patterns SSP, and the color measuring values obtained by the color measurement device 310 are values that are expressed as color components of L*a*b* color space. Particularly, in this embodiment, as the color values and color measuring values, brightness (L*) of components of L*a*b* color space is used. This is because brightness is most likely to be influenced by the density change of the color values, and is appropriate to be used as color values for obtaining the density correction values H. However, the invention is not limited thereto. The other components (a*, b*) may be used, or a group consisting of L*, a*, and, b* may also be used. In addition thereto, a value obtained by weighted summation at a certain ratio L*, a*, and, b* (e.g., 2:1:1), or color components of other color spaces (e.g., XYZ color space, or L*u*v* color space) may be used. The color measurement device 310 includes an interface 312, a CPU 313, and a color measurement device controller 315 having a memory 314, and sends the data of the color measuring values to the color-measurement-device driver of the computer 110 through the interface 312.

### Procedures of Correction-Value Obtaining Process of First Modified Example

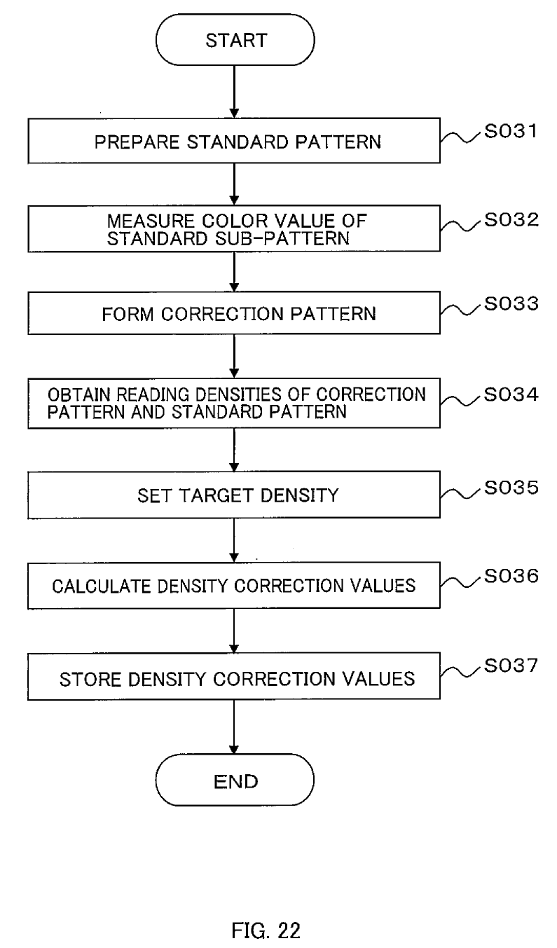

Next, procedures of the correction-value obtaining process of the first modified example are described with reference to FIG. 22. FIG. 22 is a flowchart of the correction-value obtaining process of the first modified example. Note that, in the description below, the correction-value obtaining process of a certain color of ink is described in the same way as the present example.

As shown in FIG. 22, in the correction-value obtaining process of the first modified example, the same standard pattern SP as the present example is first prepared ($031). Next, the color measurement device 310 measures color values of, that is, brightness of, each of the standard sub-patterns SSP of the standard pattern SP (S032). Next, the correction pattern CP is formed using the printer 1 (S033). At this stage, the correction pattern CP including a plurality of correction sub-patterns CSP whose densities are different from one another is formed. Next, the correction pattern CP and standard pattern SP are read with the scanner 120, and the correction-sub-pattern reading densities of the correction sub-patterns CSP are obtained together with the standard-sub-pattern reading densities of the standard sub-patterns SSP (S034) Next, the target densities are set based on the correspondence between the measured brightnesses and standard-sub-pattern reading densities of the standard sub-patterns SSP (S035). Next, the density correction values H are obtained with respect to the set target densities (S036). Then, the obtained density correction values H are stored in the memory 53 of the printer 1 (S037) Of the procedures the correction-value obtaining process of the first modified example, different points from the correction-value obtaining process of the present example are described below.

### Measuring Color Values

In the correction-value obtaining system 300 of the first modified example, brightness as a color value is measured for each standard sub-pattern SSP by the color measurement device 310, and the data of the measured brightness is obtained. The obtained data of the measured brightness for each standard sub-pattern SSP is sent from the color measurement device 310 to the color-measurement-device driver of the computer 110.

Incidentally, each designated tone value corresponds to each of the target brightnesses. Therefore, when determining a designated tone value, a target brightness corresponding to that designated tone value is determined. Here, the target brightness means a brightness (theoretical measured brightness) of the image that is ideally printed based on a certain designated tone value. In the case of a printer, such as a reference printer, which does not need the density correction, when printing an image with a certain designated tone value, an image having a brightness substantially equal to the target brightness corresponding to the certain designated tone value is printed. That is, in the standard pattern SP formed by the reference printer, the measured brightness of a certain standard sub-pattern SSP is substantially equal to the target brightness corresponding to a designated tone value with which the certain standard sub-pattern SSP is formed.

### Formation of Correction Pattern CP in First Modified Example

In the first modified example, in the similar manner as the present example, based on five designated tone values that are different from each other, the correction pattern CP including the five correction sub-patterns CSP whose densities are different from each other is formed on the correction sheet S2. In the modified example, the correction sub-patterns CSP are also arranged from left to right in ascending order of darkness. However, in the first modified example, the correction pattern CP is not necessarily formed so that each of the correction sub-patterns CSP mate with any of standard sub-patterns SSP and the correction sub-pattern CSP and standard sub-pattern SSP that mate with each other have the same density. In other words, in the first modified example, the designated tone value of each correction sub-pattern CSP is determined independently of the designated tone values of the standard sub-patterns SSP. Accordingly, the designated tone value of the n-th correction sub-pattern CSP from the left in the correction pattern CP does not necessarily agree with the designated tone value of the n-th standard sub-pattern SSP from the left in the standard pattern SP.

On the other hand, the respective designated tone values of the correction sub-patterns CSP are determined in advance, and the correction pattern CP including the five correction sub-patterns CSP is formed based on the determined five designated tone values. Here, as mentioned above, as determining the designated tone values, the target brightness corresponding to the designated tone value are also determined. Accordingly, forming the correction pattern CP including the five correction sub-patterns CSP based on the determined five designated tone values means forming the correction pattern CP in such a manner as the value of the brightness of each correction sub-pattern CSP is the same as that of the target brightness determined for each correction sub-pattern CSP. The target brightnesses determined for the five correction sub-patterns CSP are represented below by the symbols Lr1 (designated tone value Sr1), Lr2 (Sr2), Lr3 (Sr3) , Lr4 (Sr4), and Lr5 (Sr5) respectively from the left pattern.

### Setting Target Density in First Modified Example

In the first modified example, in setting the target density, in the similar manner as the present example, the densities of all the pixels in the image data of each standard sub-pattern SSP are first calculated, and the average density of all the pixels is obtained.

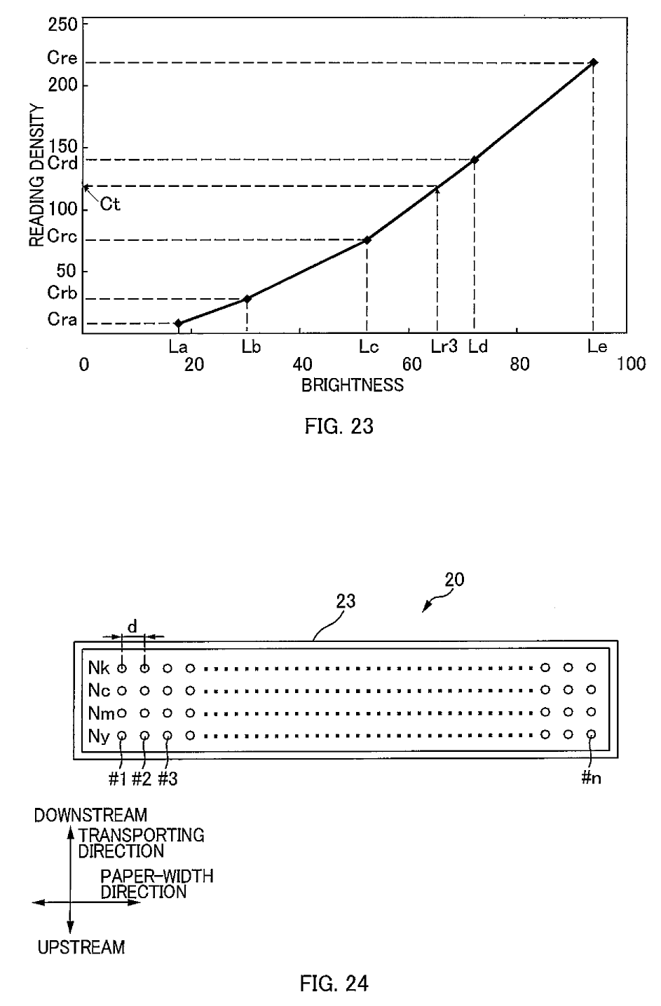

Thereafter, with respect to the target brightness determined for each correction sub-pattern CSP, a density corresponding to that brightness is obtained, and that density is set as the target density. That is, in the first modified example, with respect to the target brightness determined for each correction sub-pattern CSP, the value of the target density is set. With reference to FIG. 23, specific procedures are described below. FIG. 23 is an explanatory diagram of procedures for setting the target density in the first modified example.

Regarding the target brightness determined for a certain correction sub-pattern CSP, the value of the target density is obtained based on the correspondence between measured brightnesses of the standard sub-patterns SSP and the standard-sub-pattern reading densities (specifically, the above-mentioned average densities).

More specific explanation is given below. With reference to FIG. 23, an example is described in which the target density is set with respect to a target brightness determined for a certain correction sub-pattern CSP (e.g., the third correction sub-pattern CSP from the left); in this example, the target brightness is Lr3 (designated tone value Sr3). Here, the correspondences between the measured brightnesses of the standard sub-patterns SSP and the standard-sub-pattern reading densities are represented by (La, Cra), (Lb, Crb), (Lc, Crc), (Ld, Crd), (Le, Cre) respectively from the left sub-pattern.

First, of target brightnesses smaller than the target brightness Lr3, a correspondence between a target brightness whose value is closet to the target brightness Lr3 and the measured brightness of a correction sub-pattern CSP that formed to be that target brightness is determined. Also, of target brightnesses larger than the target brightness Lr3, a correspondence between a target brightness whose value is closet to the target brightness Lr3 and the measured brightness of a correction sub-pattern CSP that formed to be that target brightness is determined. In the example shown in FIG. 23, a density corresponding to the target brightness Lr3 is obtained using linear approximation based on the correspondences (Lc, Crc), (Ld, Crd), as shown in FIG. 23. The obtained density is set as a target density Ct.

Note that, in the modified example, the density corresponding to the target brightness is obtained using linear approximation, but this invention is not limited thereto. For example, the density corresponding to the target brightness may be obtained using spline approximation based on the correspondence between the measured brightness of each standard sub-pattern SSP and the standard-sub-pattern reading density.

### Calculation of Density Correction Values H in First Modified Example

In the first modified example, the density correction values H are obtained for each raster line by the correction-value obtaining program, based on the correction-sub-pattern reading density, using as the target density a density obtained based on the correspondence between the measured brightness of each standard sub-pattern SSP and the standard-sub-pattern reading density. Here, the calculation of the density correction value H for each raster line is performed using, as the target density, a density corresponding to the target brightness of one of the plurality of correction sub-patterns CSP, and the density correction value H is obtained in order to correct the designated tone value that is used in forming that correction sub-pattern CSP. This is because some of raster lines constituting that correction sub-pattern CSP formed by the printer 1 that is to undergo the correction-value obtaining process are brighter (darker) than the target brightness determined for that correction sub-pattern CSP due to reflecting of the density unevenness characteristics.

A specific explanation is given below. A case is described in which that correction sub-pattern CSP formed so as to have the target brightness Lr3 (that is, the pattern is formed based on the designated tone value Sr3 that is determined with respect to the target brightness Lr3).

In the case where, regarding a certain raster line i of a correction sub-pattern CSP that has been formed so as to have target brightness Lr3, if its correction-sub-pattern reading density is lower than the target density Ct, a density correction value H that makes the designated tone value larger is obtained. On the other hand, regarding the certain raster line i, if its correction-sub-pattern reading density is higher than the target density Ct, a density correction value H that makes the designated tone value smaller is obtained.

Using the density corresponding to the target brightness Lr3 of that correction sub-pattern CSP as the target density Ct, the density correction value H for each raster line is obtained based on the correction-sub-pattern reading density of that correction sub-pattern CSP and the correction-sub-pattern reading density of at least one of the correction sub-patterns CSP other than that correction sub-pattern CSP. Specifically, the density correction value H is obtained for each raster line based on the following correction-sub-pattern reading densities: the correction-sub-pattern reading density of that correction sub-pattern CSP; the correction-sub-pattern reading density of a correction sub-pattern CSP that is formed based on the designated tone value that is closest to Sr3 (the designated tone value of that correction sub-pattern CSP) among designated tone values smaller than Sr3; and the correction-sub-pattern reading density of a correction sub-pattern CSP that is formed based on the designated tone value that is closest to Sr3 among designated tone values larger than Sr3.

Then, with respect to the target brightness of each correction sub-pattern CSP (in other words, the designated tone value when forming each correction sub-pattern CSP), the density correction value H is obtained for each raster line. As a result, in a similar manner as the present example, the correction-value table of the density correction values H obtained for each raster line is created in the memory 53 of the printer 1.

### Advantages of First Modified Example and Present Example

As mentioned above, in the first modified example, when obtaining the density correction value H for a certain designated tone value, the reading density of the image that is formed ideally based on the certain designated tone value is calculated using linear approximation based on the target brightness for the certain designated tone value, and the density is set as the target density. This enables the target density to be set with substantially the same precision as the case where the reading density of the standard pattern SP formed based on the certain designated tone value is used as the target density (that is, the present example). As a result, it is possible to obtain an appropriate density correction value H.

Besides, in the first modified example, unlike the present example, it is not necessary to form the correction pattern CP in such a manner as each of the correction sub-patterns CSP mates with any of the standard sub-patterns SSP, and the mated correction sub-pattern CSP and standard sub-pattern SSP have the same density. Therefore, in the first modified example, compared to the present example, the correction pattern CP can be formed more easily. In the terms thereof, the first modified example is more desirable.

On the other hand, when obtaining the density correction value H for a certain designated tone value, in the present example, the standard pattern SP (more specifically, standard sub-patterns SSP) formed based on the certain designated tone values is prepared, and the reading density of the standard pattern SP is used as the target density. In contrast, in the first modified example, as mentioned above, the reading density of the image that is formed ideally based on the certain designated tone value is calculated using linear approximation based on the target brightness for the certain designated tone value, and the density is set as the target density. Accordingly, compared to the first modified example, it is possible to, in the present example, set more easily the target density. In the terms thereof, the present example is more desirable.

### Other Embodiments

As mentioned above, the method for obtaining correction values according to the invention was mainly described based on the foregoing embodiments. The above-mentioned description also disclosed the correction-value obtaining systems 200, 300 for performing the method for obtaining correction values and the printer 1 that stores density correction values H with the method for obtaining correction values. The above-mentioned embodiments of the invention are provided for facilitating the understanding of the invention, and are not to be interpreted as limiting the invention. As a matter of course, the invention can be altered and improved without departing from the gist thereof and the invention includes equivalent thereof.

Further, in the above-mentioned embodiments, piezo method is described in which in order to eject liquid from a nozzle, an ink chamber is extended and contracted by driving a piezo element. However, thermal method is also acceptable in which bubbles are generated in a nozzle using heating elements, and the bubbles make liquid to be ejected. Besides, in the above-mentioned embodiment, interlacing is described as a printing method of the printer 1, but the invention is not limited thereto. For example, a method (overlapping) in which one raster line is formed with different nozzles is also acceptable.

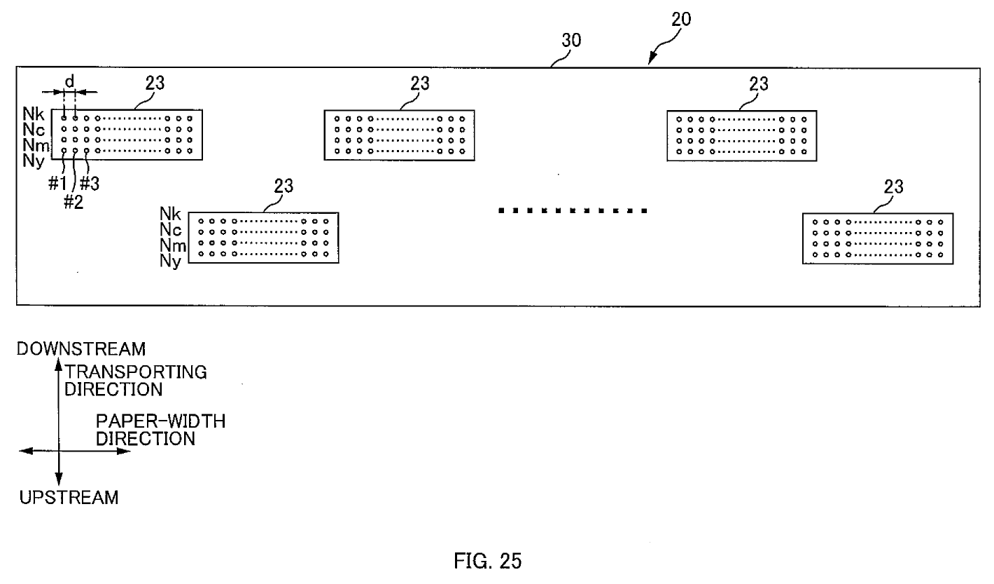

Further, in the above-mentioned embodiments, the recording unit 20 includes the single head 23 that moves in the scanning direction. That is, the printer 1 according to the above-mentioned embodiments is a serial printer that forms on paper an image composed of a plurality of dot rows lined up in the transporting direction, by alternately repeating the transporting process in which a medium is transported in the transporting direction intersecting the scanning direction, and the dot-row forming process in which a raster line extending along the scanning direction is formed on the medium by moving the head 23 in the scanning direction and ejecting ink from the nozzles. However, the invention is not limited thereto. The invention can be applied to line printers, in which dots of a whole line having the width of paper is formed at a time. Some line printers have a recording unit 20 including a head 23 elongated in the paper-width direction (see FIG. 24), and others have a recording unit 20 including a plurality of heads 23 lined up in the paper-width direction (see FIG. 25). FIG. 24 is an explanatory diagram of the line printer including the elongated head 23 (line-head printer) as the first modified example of the printer 1. FIG. 25 is an explanatory diagram of the line printer including the plurality of heads 23 (multi-head printer) as the second modified example of the printer 1. The arrows in FIGS. 24 and 25 indicate the paper-width direction and the transporting direction of paper.

In the line printer, as shown in FIGS. 24 and 25, a plurality of the nozzles lined up in the paper-width direction (hereinafter referred to as a nozzle row) are formed for each color of ink. Then, ink is ejected on a sheet of paper that keeps moving under nozzle rows in the transporting direction without stopping; thereby an image is formed on the paper. Accordingly, in the case where the correction pattern CP is formed by the line printer, a plurality of raster lines extending along the transporting direction are lined up in the paper-width direction and constitute the correction pattern CP. In other words, in the case of the line printer, the transporting direction of paper corresponds to the predetermined direction.

As mentioned above, a direction in which raster lines extend is different between the line printers and serial printers, but in both of the printers, strip-like density unevennesses (in the case of line-head printer, longitudinal strip-like density unevennesses) occur in an image due to the difference in density between raster lines. Therefore, in the case of line printer, in order to suppress density unevenness in an image, density correction values H are obtained for each raster line. As the method for obtaining such density correction values H, the method for obtaining correction values of the invention can be applied.

Further, in the above-mentioned embodiments, the inkjet printer that ejects ink, which is an example of ink, is described, but the invention is not limited thereto. The same technology as mentioned in the present embodiment can be realized in liquid ejecting apparatuses that eject liquid other than ink. For example, textile printing equipment for applying color to fabric, color filter manufacturing equipment, manufacturing equipment of display such as organic EL display, DNA chip manufacturing equipment for manufacturing DNA chips by applying DNA solution to chips, circuit board manufacturing equipment, etc. are also acceptable. The invention can be applied to any of the above-mentioned liquid ejecting apparatuses.

What is claimed is:

1. A method for obtaining correction values, comprising:
forming, on a medium, a correction pattern in which a plurality of dot rows extending along a predetermined direction are lined up in a direction intersecting the predetermined direction;
obtaining a correction-pattern reading density of each of the dot rows of the correction pattern together with a standard-pattern reading density of a standard pattern, by reading the correction pattern together with the standard pattern; and
obtaining a density correction value that is used in correcting a density of an image, for each of the dot rows, based on the correction-pattern reading density, with respect to a target density that is set based on the standard-pattern reading density.

2. A method for obtaining correction values according to claim 1, wherein
the standard pattern has a plurality of standard sub-patterns that are different in density from each other;
in forming the correction pattern on the medium,
the correction pattern having a plurality of correction sub-patterns that are different in density from each other is formed in such a manner as each of the correction sub-patterns mates with one of the standard sub-patterns and the mated correction sub-pattern and standard sub-pattern have a same density;
in obtaining the correction-pattern reading density together with the standard-pattern reading density,
a correction-sub-pattern reading density of each of the dot rows of each of the correction sub-patterns is obtained together with a standard-sub-pattern reading density of each of the standard sub-patterns; and
in obtaining the density correction value,
the density correction value is obtained for each dot row using a standard-sub-pattern reading density of one of the plurality of standard sub-patterns as the target density, based on a correction-sub-pattern reading density of a correction sub-pattern that mate with that standard sub-pattern and a correction-sub-pattern reading density of at least one of a correction sub-pattern other than the correction sub-pattern that mates with that standard sub-pattern.

3. A method for obtaining correction values according to claim 2, wherein
in obtaining the correction-pattern reading density together with the standard-pattern reading density,
a scanner including a plurality of reading sensors arranged in a line reads the correction pattern together with the standard pattern, with the mated standard sub-pattern and correction sub-pattern being lined up at a same position in a direction in which the reading sensors are arranged.

4. A method for obtaining correction values according to claim 1, wherein
the standard pattern has a plurality of standard sub-patterns that are different in density from each other;
measuring a color value of each of the standard sub-patterns by a color measurement device is included;
in forming the correction pattern on the medium,
the correction pattern having a plurality of correction sub-patterns that are different in density from each other is formed on the medium in such a manner as a color value of each of the correction sub-patterns is the same as a target color value determined with respect to that correction sub-pattern;
in obtaining the correction-pattern reading density together with the standard-pattern reading density,
a correction-sub-pattern reading density of each of the dot rows of each of the correction sub-patterns is obtained together with a standard-sub-pattern reading density of each of the standard sub-patterns; and
in obtaining the density correction value,
the density correction value is obtained for each dot row using, as the target density, a density corresponding to a target color value of one of the plurality of correction sub-patterns, based on a correction-sub-pattern reading density of that correction sub-pattern and a correction-sub-pattern reading density of at least one of a correction sub-pattern other than that correction sub-pattern,
the target color value being obtained based on a correspondence between the color value of the standard sub-pattern and the standard-sub-pattern reading density.

5. A method for obtaining correction values according to claim 1, wherein
in forming the correction pattern on the medium,
the correction pattern is formed on a different medium from a medium on which the standard pattern is formed.

6. A method for obtaining correction values according to claim 5, wherein
in forming the correction pattern on the medium,
the correction pattern is formed on a medium of a same type as the medium on which the standard pattern is formed, with a liquid of a same type as a liquid used in forming the standard pattern.

7. A liquid ejecting apparatus, comprising:
a nozzle that ejects liquid;
a controller that makes the nozzle eject the liquid and forms on a medium a correction pattern in which a plurality of dot rows extending along a predetermined direction are lined up in a direction intersecting the predetermined direction; and
a memory that stores a density correction value
that is used in correcting a density of an image, and
that is obtained for each dot row using, as a target density, a density that is set based on a standard-pattern reading density of a standard pattern read together with the correction pattern, based on a correction-pattern reading density obtained for each of the dot rows by reading the correction pattern.
